(19) United States
(12) Patent Application Publication
(10) Pub. No.: US 2023/0378540 A1
(43) Pub. Date: Nov. 23, 2023

(54) RECHARGEABLE BATTERY CELL

(71) Applicant: Innolith Technology AG, Basel (CH)

(72) Inventors: Laurent Zinck, Mothern (FR); Leonard Henrichs, Bruchsal (DE)

(21) Appl. No.: 18/361,436

(22) Filed: Jul. 28, 2023

Related U.S. Application Data
(63) Continuation of application No. PCT/EP2022/051745, filed on Jan. 26, 2022.

(30) Foreign Application Priority Data
Jan. 29, 2021 (EP) 21 154 307.9

(51) Int. Cl. H01M 10/0568; H01M 10/0567; H01M 10/0525

(52) U.S. Cl. CPC H01M 10/0568; H01M 10/0567; H01M 10/0525

(57) ABSTRACT

This disclosure relates to a rechargeable battery cell containing an active metal, at least one positive electrode with a discharge element, at least one negative electrode with a discharge element, a housing, and an electrolyte, the discharge element of the positive electrode and the discharge element of the negative electrode being embodied independently of one another from a material selected from the group formed by aluminum and copper, and wherein the electrolyte is based on SO₂ and contains at least one conductive salt which has the formula (I),

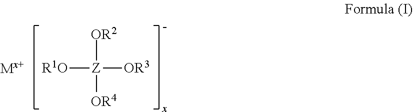

wherein M is a metal selected from the group formed by alkali metals, alkaline earth metals, metals of group 12 of the periodic table of elements, and aluminum; x is an integer from 1 to 3; the substituents R¹, R², R³, and R⁴ are selected independently of one another from the group formed by C₁-C₁₀ alkyl, C₂-C₁₀ alkenyl, C₂-C₁₀ alkynyl, C₃-C₁₀ cycloalkyl, C₆-C₁₄ aryl, and C₅-C₁₄ heteroaryl; and wherein Z is aluminum or boron.

### RELATED APPLICATIONS

This application is a continuation of PCT/EP2022/051745, filed Jan. 26, 2022, which claims priority to EP 21 154 307.9, filed Jan. 29, 2021, the entire disclosures of both of which are hereby incorporated herein by reference.

### BACKGROUND

This disclosure relates to a rechargeable battery cell with an SO₂-based electrolyte.

Rechargeable battery cells are of great importance in many technical fields. They are often used for applications that only require small, rechargeable battery cells with relatively low current strengths, such as when operating mobile phones. In addition, however, there is also a great need for larger rechargeable battery cells for high-energy applications, mass storage of energy in the form of battery cells for the electric driving of vehicles being of particular importance.

An important requirement for such rechargeable battery cells is high energy density. This means that the rechargeable battery cell should contain as much electrical energy as possible per unit of weight and volume. Lithium has proven to be particularly advantageous as the active metal for this purpose. Rechargeable battery cells that contain lithium as the active metal are also referred to as lithium-ion cells. The energy density of these lithium-ion cells can be increased either by increasing the specific capacity of the electrodes or by increasing the cell voltage.

Both the positive and the negative electrode of lithium-ion cells are designed as insertion electrodes. The term “insertion electrode” in the context of this disclosure is understood to mean electrodes which have a crystal structure in which ions of the active metal can be intercalated and from which ions of the active metal can be deintercalated during operation of the lithium-ion cell. The active metal of a rechargeable battery cell is the metal whose ions migrate within the electrolyte to the negative or positive electrode during charging or discharging of the cell and take part in electrochemical processes there. In the case of an insertion electrode, this means that the electrode processes can take place not only on the surface of the electrodes, but also within the crystal structure. When charging the lithium-ion cell, the ions of the active metal are deintercalated from the positive electrode and intercalated in the negative electrode. The reverse process takes place when the lithium-ion cell is discharged. These electrochemical processes lead directly or indirectly to the release of electrons into the external circuit or to the electrons being taken up from the external circuit. The positive and negative electrodes of the lithium-ion cell each have a discharge element so that the electrons can be released into the external circuit or taken up from the external circuit. These discharge elements are important components of the positive and negative electrodes. The electrons (e⁻) released in the electrode reactions of the first electrode are released into the external circuit via their discharge element. The electrons required for the electrode reactions of the second electrode are supplied by the discharge element of this electrode from the external circuit. Good electronic conductivity of both discharge elements is a prerequisite for the battery cell having a high current carrying capacity. The discharge elements can be embodied, for example, planar in the form of a metal sheet or three-dimensional in the form of a porous metal foam. The active materials of the negative or positive electrode are incorporated into the metal foam or applied to the planar metal sheet of the discharge elements. The active material in the metal foam and the coating of the planar metal sheet with the active material are porous, so that the electrolyte used can penetrate into the respective porous structure and is therefore in contact with the respective discharge element. When charging and discharging a battery cell, a potential difference is built up between the electrodes. Reactions of the discharge element with the active electrode materials or the electrolyte can be promoted by this potential difference. In the corresponding potential range, the material of the discharge element must therefore be inert both to the active electrode materials used and to the electrolyte used, without undesired secondary reactions taking place. Therefore, when choosing a suitable discharge element, the electrolyte used and the expected potential range must be taken into account. In the text below, the terms “discharge element,” “conductor” and “current collector” are synonyms.

The electrolyte is also an important functional element of every rechargeable battery cell. It usually contains a solvent or a mixture of solvents and at least one conductive salt. Solid electrolytes or ionic liquids, for example, do not contain any solvents, only the conductive salt. The electrolyte is in contact with the positive and negative electrodes of the battery cell. At least one ion of the conductive salt (anion or cation) is mobile in the electrolyte in such a way that ion conduction allows a charge transport between the electrodes to take place, which is necessary for the functioning of the rechargeable battery cell. Above a certain upper cell voltage of the rechargeable battery cell, oxidation electrochemically decomposes the electrolyte. This process often leads to irreversible destruction of components of the electrolyte and thus to failure of the rechargeable battery cell. Reductive processes can also decompose the electrolyte above a certain lower cell voltage. In order to avoid these processes, the positive and negative electrodes are selected in such a way that the cell voltage is below or above the decomposition voltage of the electrolyte. The electrolyte thus determines the voltage window in which a rechargeable battery cell can be operated reversibly, that is (i.e.), repeatedly charged and discharged.

The lithium-ion cells known from the prior art contain an electrolyte which comprises an organic solvent or solvent mixture and a conductive salt dissolved therein. The conductive salt is a lithium salt such as, e.g., lithium hexafluorophosphate (LiPF₆). The solvent mixture can contain ethylene carbonate, for example. The electrolyte LP57, which has the composition 1 M LiPF₆ in EC:EMC 3:7, is an example of such an electrolyte. Because of the organic solvent or solvent mixture, such lithium-ion cells are also referred to as organic lithium-ion cells.

Other conductive salts for organic lithium-ion cells are also described, in addition to the lithium hexafluorophosphate (LiPF₆) frequently used as a conductive salt in the prior art. For example, JP 4 306858 B2 (hereinafter referred to as [V1]) describes conductive salts in the form of tetraalkoxy or tetraaryloxyborate salts, which can be fluorinated or partially fluorinated. JP 2001 143750 A (hereinafter referred to as [V2]) reports on fluorinated or partially fluorinated tetraalkoxyborate salts and tetraalkoxyaluminate salts as conductive salts. In both documents [V1] and [V2], the conductive salts described are dissolved in organic solvents or solvent mixtures and used in organic lithium-ion cells.

It has long been known that accidental overcharging of organic lithium-ion cells leads to irreversible decomposition of electrolyte components. In this case, the oxidative decomposition of the organic solvent and/or the conductive salt takes place on the surface of the positive electrode. The reaction heat generated during this decomposition and the resulting gaseous products are responsible for the subsequent so-called “thermal runaway” and the resulting destruction of the organic lithium-ion cell. The vast majority of charging protocols for these organic lithium-ion cells use cell voltage as an indicator for end-of-charge. Thermal runaway accidents are particularly likely when using multi-cell battery packs in which several organic lithium-ion cells with mismatched capacities are connected in series.

Therefore, organic lithium-ion cells are problematic in terms of their stability and long-term operational reliability. Safety risks are also caused in particular by the flammability of the organic solvent or solvent mixture. If an organic lithium-ion cell catches on fire or even explodes, the organic solvent of the electrolyte forms a combustible material. Additional measures must be taken in order to avoid such safety hazards. These measures include, in particular, very precise control of the charging and discharging processes of the organic lithium-ion cell and optimized battery design. Furthermore, the organic lithium-ion cell contains components that melt when the temperature is unintentionally increased and that can then flood the organic lithium-ion cell with molten plastic. This avoids a further uncontrolled increase in temperature. However, these measures lead to increased production costs during production of the organic lithium-ion cell and to increased volume and weight. Furthermore, these measures reduce the energy density of the organic lithium-ion cell.

One further refinement known from the prior art provides for the use of an electrolyte based on sulfur dioxide (SO₂) instead of an organic electrolyte for rechargeable battery cells. Rechargeable battery cells which contain an SO₂-based electrolyte have, among other things, high ionic conductivity. In the context of this disclosure, the term “SO₂-based electrolyte” is understood to mean an electrolyte that not only contains SO₂ in a low concentration as an additive, but in which the mobility of the ions of the conductive salt contained in the electrolyte is reduced and the charge transport is at least partially, largely, or even fully provided by SO₂. The SO₂ thus serves as a solvent for the conductive salt. The conductive salt is, e.g., often lithium tetrachloroaluminate (LiAlCl₄), which forms a liquid solvate complex with the gaseous SO₂, the SO₂ being bonded and the vapor pressure being noticeably reduced compared to pure SO₂. Electrolytes with a low vapor pressure are formed. Such electrolytes based on SO₂ have the advantage of non-combustibility compared to the organic electrolytes described above. Safety risks due to the combustibility of the electrolyte can thus be ruled out.

For example, EP 2 534 725 B 1 (hereinafter referred to as [V3]) discloses a rechargeable battery cell with an SO₂-based electrolyte which preferably contains a tetrahalogenoaluminate, in particular LiAlCl₄, as the conductive salt.

With regard to discharge elements, [V3] states, “. . . nickel or a nickel alloy is often used for the current collectors to and from the electrodes . . . ” This document further states that nickel foam is commonly used as a discharge for the electrodes.

A rechargeable battery cell with an SO₂-based electrolyte is also found in US 2004/0157129 A1 (hereinafter referred to as [V4]). The inventors of [V4] have found that undesired reactions take place between the discharge element and the SO₂-based electrolyte, in particular the chloride-containing conductive salts, such as LiAlCl₄. This problem occurs in particular with battery cells that reach very high cell voltages (more than 4 volts) when charging. The problem is solved using a battery cell in which an electronically conductive discharge element of at least one electrode contains an alloy of chromium with another metal and/or a protective metal in a surface layer as a reaction protection material that protects the discharge element from undesired reactions.

EP 2534719 B 1 (hereinafter referred to as [V5]) also discloses an SO₂-based electrolyte with, inter alia, LiAlCl₄ as the conductive salt. This LiAlCl₄, with the SO₂, forms, for example, complexes of the formula LiAlCl₄*1.5 mol SO₂ or LiAlCl₄*6 mol SO₂. Lithium iron phosphate (LiFePO₄) is used as the positive electrode in [V5]. LiFePO₄ has a lower cut-off voltage (3.7 V) than LiCoO₂ (4.2 V). The problem of the undesired reactions of the discharge element does not occur in this rechargeable battery cell, since upper potentials of 4.1 volts are not reached.

Another problem with SO₂-based electrolytes is that many conductive salts, especially those known for organic lithium-ion cells, are not soluble in SO₂.

TABLE 2
Solubilities of Various Conductive Salts in SO₂

| | Solubility/ | | Solubility/ |
|---|---|---|---|
| Conductive Salt | mol/L in SO₂ | Conductive Salt | mol/L in SO₂ |
| LiF | 2.1 · 10⁻³ | LiPF₆ | 1.5 · 10⁻² |
| LiBr | 4.9 · 10⁻³ | LiSbF₆ | 2.8 · 10⁻⁴ |
| Li₂SO₄ | 2.7 · 10⁻⁴ | LiBF₂(C₂O₄) | 1.4 · 10⁻⁴ |
| LiB(C₂O₄)₂ | 3.2 · 10⁻⁴ | CF₃SO₂NLiSO₂CF₃ | 1.5 · 10⁻² |
| Li₃PO₄ | — | LiBO₂ | 2.6 · 10⁻⁴ |
| Li₃AlF₆ | 2.3 · 10⁻³ | LiAlO₂ | 4.3 · 10⁻⁴ |
| LiBF₄ | 1.7 · 10⁻³ | LiCF₃SO₃ | 6.3 · 10⁻⁴ |
| LiAsF₆ | 1.4 · 10⁻³ | | |

Measurements showed that SO₂ is a poor solvent for many conductive salts, such as, e.g., lithium fluoride (LiF), lithium bromide (LiBr), lithium sulfate (Li₂SO₄), lithium bis(oxalato)borate (LiBOB), lithium hexafluoroarsenate (LiAsF₆), lithium tetrafluoroborate (LiBF₄), trilithium hexafluoroaluminate (Li₃AlF₆), lithium hexafluoroantimonate (LiSbF₆), lithium difluoro(oxalato)borate (LiBF₂C₂O₄), lithium bis(trifluoromethanesulfonyl)imide (LiTFSI), lithium metaborate (LiBO₂), lithium aluminate (LiAlO₂), lithium triflate (LiCF₃SO₃), and lithium chlorosulfonate (LiSO₃Cl). The solubility of these conductive salts in SO₂ is approx. 10⁻²-10⁻⁴ mol/L (see Table 2). With these low salt concentrations, it can be assumed that the conductivities are only low and are not sufficient for the sensible operation of a rechargeable battery cell.

### SUMMARY

In order to further improve the possible uses and properties of rechargeable battery cells containing an SO₂-based electrolyte, this disclosure teaches improvements, compared to the rechargeable battery cells known in the prior art, in a rechargeable battery cell with an SO₂-based electrolyte which,
has electrodes with inert discharge elements that show no reactions with the SO₂-based electrolyte and are stable even at higher charging potentials;
has electrodes with discharge elements that neither dissolve at high potentials nor accelerate oxidative decomposition of the electrolyte. In addition, reactions for forming a top layer must not be impaired;
has a wide electrochemical window so that oxidative electrolyte decomposition does not occur at the positive electrode;
has a stable top layer on the negative electrode, the top layer capacity being low and no further reductive electrolyte decomposition occurring on the negative electrode during further operation;
contains an SO₂-based electrolyte which has good solubility for conductive salts and is therefore a good ion discharge and electronic insulator so that ion transport can be facilitated and self-discharge can be kept to a minimum;
contains an SO₂-based electrolyte that is also inert with respect to other components of the rechargeable battery cell, such as separators, electrode materials, and cell packaging materials;
is robust against various abuses such as electrical, mechanical, and thermal abuses;
contains an SO₂-based electrolyte that has increased stability with respect to residual amounts of water in the cell components of rechargeable battery cells;
has improved electrical performance data, in particular a high energy density;
has improved overcharge capability and deep discharge capability and lower self-discharge;
has enhanced service life, in particular a high number of usable charging and discharging cycles; and,
has the lowest possible price and high availability. This is of particular importance for large batteries or for batteries with a wide distribution.

Such rechargeable battery cells in particular also have very good electrical energy and performance data, high operational reliability and service life, in particular a large number of usable charging and discharging cycles, without the electrolytes decomposing during operation of the rechargeable battery cell.

An inventive rechargeable battery cell comprises an active metal, at least one positive electrode with a discharge element, at least one negative electrode with a discharge element, a housing, and an electrolyte. The discharge element of the positive electrode and the discharge element of the negative electrode are embodied independently of one another from a material selected from the group formed by aluminum and copper. The electrolyte is based on SO₂ and contains at least one first conductive salt. This first conductive salt has the formula (I):

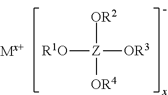

In formula (I), M is a metal selected from the group formed by alkali metals, alkaline earth metals, metals from group 12 of the periodic table of elements, and aluminum. x is an integer from 1 to 3. The substituents R¹, R², R³, and R⁴ are selected independently of one another from the group formed by C₁-C₁₀ alkyl, C₂-C₁₀ alkenyl, C₂-C₁₀ alkynyl, C₃-C₁₀ cycloalkyl, C₆-C₁₄ aryl, and C₅-C₁₄ heteroaryl. The central atom Z is either aluminum or boron.

In the context of this disclosure, the term “discharge element” refers to an electronically conductive element which enables the required electronically conductive connection of an active material of the respective electrode to the external circuit. For this purpose, the respective discharge element is in electronically conductive contact with the active material involved in the electrode reaction of the respective electrode.

The SO₂-based electrolyte used in the inventive rechargeable battery cell contains SO₂ not only as an additive in a low concentration, but also in concentrations at which the mobility of the ions of the first conductive salt, which is contained in the electrolyte and causes charge transport, is at least partially, largely or even completely guaranteed by the SO₂. The first conductive salt is dissolved in the electrolyte and exhibits very good solubility therein. With the gaseous SO₂, it can form a liquid solvate complex in which the SO₂ is bound. In this case, the vapor pressure of the liquid solvate complex drops significantly compared to pure SO₂ and electrolytes with a low vapor pressure result. However, it is also within the scope of this disclosure that, depending on the chemical structure of the first conductive salt according to formula (I), no reduction in vapor pressure can occur during the production of the inventive electrolyte. In the latter case, it is preferred that the inventive electrolyte is produced at low temperature or under pressure. The electrolyte can also contain a plurality of conductive salts of formula (I) which differ from one another in their chemical structure.

In the context of this disclosure, the term “C₁-C₁₀ alkyl” includes linear or branched saturated hydrocarbon groups having one to ten carbon atoms. These include, in particular, methyl, ethyl, n-propyl, isopropyl, n-butyl, sec-butyl, isobutyl, tert-butyl, n-pentyl, isopentyl, 2,2-dimethylpropyl, n-hexyl, isohexyl, 2-ethylhexyl, n-heptyl, iso-heptyl, n-octyl, iso-octyl, n-nonyl, n-decyl and the like.

In the context of this disclosure, the term “C₂-C₁₀ alkenyl” includes unsaturated linear or branched hydrocarbon groups with two to ten carbon atoms, the hydrocarbon groups having at least one C—C double bond. These include in particular ethenyl, 1-propenyl, 2-propenyl, 1-n-butenyl, 2-n-butenyl, isobutenyl, 1-pentenyl, 1-hexenyl, 1-heptenyl, 1-octenyl, 1-nonenyl, 1-decenyl, and the like.

In the context of this disclosure, the term “C₂-C₁₀ alkynyl” includes unsaturated linear or branched hydrocarbon groups with two to ten carbon atoms, the hydrocarbon groups having at least one C—C triple bond. These include in particular ethynyl, 1-propynyl, 2-propynyl, 1-n-butynyl, 2-n-butynyl, isobutynyl, 1-pentynyl, 1-hexynyl, 1-heptynyl, 1-octynyl, 1-nonynyl, 1-decinyl, and the like.

In the context of this disclosure, the term “C₃-C₁₀ cycloalkyl” includes cyclic, saturated hydrocarbon groups with three to ten carbon atoms. These include, in particular, cyclopropyl, cyclobutyl, cyclopentyl, cyclohexyl, cycloheptyl, cyclohexyl, cyclononyl, and cyclodecanyl.

In the context of this disclosure, the term “C₆-C₁₄ aryl” includes aromatic hydrocarbon groups with six to fourteen carbon ring atoms. These include, in particular, phenyl (C₆H₅ group), naphthyl (C₁₀H₇ group), and anthracyl (C₁₄H₉ group).

In the context of this disclosure, the term “C₅-C₁₄ heteroaryl” includes aromatic hydrocarbon groups with five to fourteen ring hydrocarbon atoms in which at least one hydrocarbon atom is replaced or exchanged for a nitrogen, oxygen, or sulfur atom. These include, in particular, pyrrolyl, furanyl, thiophenyl, pyrridinyl, pyranyl, thiopyranyl, and the like. All of the aforementioned hydrocarbon groups are each bonded to the central atom according to formula (I) via the oxygen atom.

Compared to rechargeable battery cells with electrolytes known from the prior art, a rechargeable battery cell with such an electrolyte has the advantage that the first conductive salt contained therein has higher oxidation stability and consequently exhibits essentially no decomposition at higher cell voltages. This electrolyte is oxidation-stable, preferably at least up to an upper potential of 4.0 volts, more preferably at least up to an upper potential of 4.2 volts, more preferably at least up to an upper potential of 4.4 volts, more preferably at least up to an upper potential of 4.6 volts, more preferably at least to an upper potential of 4.8 volts, and particularly preferably at least to an upper potential of 5.0 volts. Thus, when such an electrolyte is used in a rechargeable battery cell, there is little or even no electrolyte decomposition within the working potential, i.e., in the range between the end-of-charge voltage and the end-of-discharge voltage of both electrodes of the rechargeable battery cell. This allows inventive rechargeable battery cells to have an end-of-charge voltage of at least 4.0 volts, more preferably at least 4.4 volts, more preferably at least 4.8 volts, more preferably at least 5.2 volts, more preferably at least 5.6 volts, and particularly preferably at least 6.0 volts. The service life of the rechargeable battery cell containing this electrolyte is significantly longer than rechargeable battery cells containing electrolytes known from the prior art.

Furthermore, a rechargeable battery cell with such an electrolyte is also resistant to low temperatures. At a temperature of, e.g., −40° C., 61% of the charged capacity can still be discharged. The conductivity of the electrolyte at low temperatures is sufficient for operating a battery cell. Furthermore, a rechargeable battery cell with such an electrolyte has increased stability with respect to residual amounts of water. If there are still small residual amounts of water in the electrolyte (in the ppm range), the electrolyte or the first conductive salt forms hydrolysis products with the water which are clearly less aggressive toward the cell components in comparison to the SO₂-based electrolytes known from the prior art. Because of this, the absence of water in the electrolyte plays a less important role in comparison to the SO₂-based electrolytes known from the prior art. These advantages of the inventive electrolyte outweigh the disadvantage that arises from the fact that the first conductive salt according to formula (I) has a significantly larger anion size compared to the conductive salts known from the prior art. This higher anion size leads to a lower conductivity of the first conductive salt according to formula (I) compared to the conductivity of LiAlCl₄.

### Discharge Elements of the Positive and Negative Electrode

Advantageous refinements of the inventive rechargeable battery cell with regard to the discharge element of the positive electrode and the discharge element of the negative electrode are described below:

According to this disclosure, both the positive electrode and the negative electrode have a discharge element. These discharge elements enable the required electronically conductive connection of the active material of the respective electrode to the external circuit. For this purpose, the discharge element is in contact with the active material involved in the electrode reaction of the respective electrode. As already mentioned above, according to this disclosure the discharge element of the positive electrode and the discharge element of the negative electrode are embodied independently of one another from a material selected from the group formed by aluminum and copper. One advantageous embodiment of the inventive rechargeable battery cell provides that the discharge element of the positive electrode comprises aluminum. In a further advantageous embodiment of the inventive rechargeable battery cell, the discharge element of the negative electrode is made of copper. The discharge element of the positive electrode and/or the discharge element of the negative electrode can either be embodied in one piece or in multiple pieces.

The discharge element of the positive electrode and/or the discharge element of the negative electrode may be planar in the form of a thin metal sheet or a thin metal film. The thin metal sheet or thin metal film can have an openwork or net-like structure. The planar discharge element can also be embodied from a metal-coated plastic film. This metal coating preferably has a thickness in the range from 0.1 μm to 20 μm. The active material of the respective electrode is preferably applied to the surface of the thin metal sheet, thin metal film, or metal-coated plastic film. The active material can be applied to the front and/or the back of the planar discharge element. Such planar discharge elements preferably have a thickness in the range of 0.5 μm to 50 μm, particularly preferably in the range of 1 μm to 20 μm. When using planar discharge elements, the respective electrode can have a total thickness of at least 20 μm, preferably at least 40 μm, and particularly preferably at least 60 μm. The maximum thickness is preferably at most 300 μm, more preferably at most 150 μm, and particularly preferably at most 100 μm.

The area-specific capacity of the positive electrode and/or of the negative electrode, relative to the coating on one side of the respective discharge element, is preferably at least 0.5 mAh/cm² when using the planar discharge element, with the following values in this order being more preferred: 1 mAh/cm², 3 mAh/cm², 5 mAh/cm², 10 mAh/cm², 15 mAh/cm², 20 mAh/cm².

If the discharge element is planar in the form of a thin metal sheet, a thin metal film, or a metal-coated plastic film, the amount of active material of the negative or positive electrode, i.e., the loading of the electrode, relative to the coating on one side, is preferably at least 1 mg/cm², more preferably at least 3 mg/cm², more preferably at least 5 mg/cm², more preferably at least 8 mg/cm², more preferably at least 10 mg/cm², and particularly preferably at least 20 mg/cm².

The maximum loading of the electrode, relative to the coating of one side, is preferably at most 150 mg/cm², more preferably at most 100 mg/cm², and particularly preferably at most 80 mg/cm².

Furthermore, there is also the possibility for the discharge element of the positive electrode and/or the discharge element of the negative electrode to be embodied three-dimensionally in the form of a porous metal structure, in particular in the form of a metal foam. The three-dimensional porous metal structure is porous such that the active material of the respective electrode can be incorporated into the pores of the metal structure. The loading of the electrode has to do with the amount of active material incorporated or applied. If the discharge element is three-dimensional in the form of a porous metal structure, in particular in the form of a metal foam, then the respective electrode preferably has a thickness of at least 0.2 mm, more preferably at least 0.3 mm, more preferably at least 0.4 mm, more preferably at least 0.5 mm, and particularly preferably at least 0.6 mm.

One further advantageous embodiment of the inventive rechargeable battery cell provides that the area-specific capacity of the positive electrode and/or of the negative electrode when using a three-dimensional discharge element, in particular in the form of a metal foam, is preferably at least 2.5 mAh/cm², the following values being more preferred in this order: 5 mAh/cm², 15 mAh/cm², 25 mAh/cm², 35 mAh/cm², 45 mAh/cm², 55 mAh/cm², 65 mAh/cm², 75 mAh/cm². If the discharge element is embodied three-dimensionally in the form of a porous metal structure, in particular in the form of a metal foam, the amount of active material of the positive or negative electrode, i.e., the loading of the respective electrode, relative to its surface area, is at least 10 mg/cm², preferably at least 20 mg/cm², more preferably at least 40 mg/cm², more preferably at least 60 mg/cm², more preferably at least 80 mg/cm², and particularly preferably at least 100 mg/cm^{2.} This loading of the respective electrode has a positive effect on the charging process and the discharging process of the rechargeable battery cell. The rechargeable battery cell can also include at least one positive electrode with a discharge element in the form of a porous metal structure, in particular in the form of a metal foam, and at least one negative electrode with a planar discharge element in the form of a thin metal sheet, thin metal film, or plastic film coated with metal. Alternatively, however, the rechargeable battery cell can also have at least one negative electrode with a discharge element in the form of a porous metal structure, in particular in the form of a metal foam, and at least one positive electrode with a planar discharge element in the form of a thin metal sheet, thin metal film, or plastic film coated with metal.

The active material of the positive electrode can cover the discharge element, at least partially or even completely. Furthermore, the active material of the negative electrode can cover the discharge element, at least partially or even completely.

Both the planar conductive element and the three-dimensional discharge element can be embodied in multiple parts. For contacting the discharge elements, the rechargeable battery cell can have additional components, such as, for example, lugs, wires, metal sheets, and the like, which are attached to the respective discharge element. These components can be embodied from the same material as the respective discharge element, that is, aluminum or copper, or from a different material.

### Electrolyte

Advantageous refinements of the rechargeable battery cell are described below with regard to the SO₂-based electrolytes.

As already described above, the substituents R¹, R², R³, and R⁴ in formula (I) of the first conductive salt are independently selected from the group formed by C₁-C₁₀ alkyl, C₂-C₁₀ alkenyl, C₂-C₁₀ alkynyl, C₃-C₁₀ cycloalkyl, C₆-C₁₄ aryl, and C₅-C₁₄ heteroaryl. In one further advantageous embodiment of the rechargeable battery cell, the substituents R¹, R², R³, and R⁴ of the first conductive salt are selected independently from the group formed by
C₁-C₆ alkyl; preferably by C₂-C₄ alkyl; particularly preferably by the alkyl groups 2-propyl, methyl, and ethyl;
C₂-C₆ alkenyl; preferably by C₂-C₄ alkenyl; particularly preferably by the alkenyl groups ethenyl and propenyl;
C₂-C₆ alkynyl; preferably by C₂-C₄ alkynyl;
C₃-C₆ cycloalkyl;
phenyl; and
C₅-C₇ heteroaryl.

In the case of this advantageous embodiment of the SO₂-based electrolyte, the term “C₁-C₆ alkyl” includes linear or branched saturated hydrocarbon groups with one to six hydrocarbon groups, in particular methyl, ethyl, n-propyl, isopropyl, n-butyl, sec-butyl, iso-butyl, tert-butyl, n-pentyl, isopentyl, 2,2-dimethylpropyl, n-hexyl, and iso-hexyl. Among these, C₂-C₄ alkyls are preferred. The C₂-C₄ alkyls 2-propyl, methyl, and ethyl are particularly preferred.

In the case of this advantageous embodiment of the SO₂-based electrolyte, the term “C₂-C₆ alkenyl” includes unsaturated linear or branched hydrocarbon groups with two to six carbon atoms, the hydrocarbon groups having at least one C—C double bond. These include, in particular, ethenyl, 1-propenyl, 2-propenyl, 1-n-butenyl, 2-n-butenyl, isobutenyl, 1-pentenyl, and 1-hexenyl, C₂-C₄ alkenyls being preferred. Ethenyl and 1-propenyl are particularly preferred.

In the case of this advantageous embodiment of the SO₂-based electrolyte, the term “C₂-C₆ alkynyl” includes unsaturated linear or branched hydrocarbon groups with two to six carbon atoms, the hydrocarbon groups having at least one C-C triple bond. These include, in particular, ethynyl, 1-propynyl, 2-propynyl, 1-n-butynyl, 2-n-butynyl, isobutynyl, 1-pentynyl, and 1-hexynyl. Preferred among these are C₂-C₄ alkynyls.

In the case of this advantageous embodiment of the SO₂-based electrolyte, the term “C₃-C₆ cycloalkyl” includes cyclic saturated hydrocarbon groups with three to six carbon atoms. These include in particular cyclopropyl, cyclobutyl, cyclopentyl, and cyclohexyl.

In the case of this advantageous embodiment of the SO₂-based electrolyte, the term “C₅-C₇ heteroaryl” includes phenyl and naphthyl.

In one further advantageous refinement of the inventive rechargeable battery cell, at least two of the substituents R¹, R², R³, and R⁴ are bridged with one another to form a bidentate chelating ligand. Such a bidentate chelating ligand can have the following structure, for example:

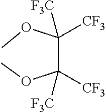 [SMILES: COC(C(F)(F)F)(C(F)(F)F)C(OC)(C(F)(F)F)C(F)(F)F]

Preferably, three or even four of the substituents R¹, R², R³, and R⁴ can also be bridged with one another to form a tridentate or tetradentate chelating ligand. The chelating ligand coordinates to the central atom Z to form a chelate complex. The term “chelate complex”—also referred to as chelate for short—stands for complex compounds in which a multidentate ligand (has more than one free electron pair) occupies at least two coordination sites (bonding sites) of the central atom. The central atom is the positively charged metal ion Al³⁺ or B³⁺. Ligands and central atom are linked via coordinate bonds, which means that the bonding pair of electrons is provided solely by the ligand.

One advantageous refinement of the inventive rechargeable battery cell has a cell voltage of at least 4.0 volts, preferably at least 4.4 volts, more preferably at least 4.8 volts, more preferably at least 5.2 volts, more preferably at least 5.6 volts, and particularly preferably at least 6.0 volts.

In one further advantageous embodiment of the rechargeable battery, in order to improve the solubility of the first conductive salt in the SO₂-based electrolyte, the substituents R¹, R², R³, and R⁴ are substituted by at least one fluorine atom and/or by at least one chemical group, the chemical group being selected from the group formed by C₁-C₄ alkyl, C₂-C₄ alkenyl, C₂-C₄ alkynyl, phenyl, and benzyl. The chemical groups C₁-C₄ alkyl, C₂-C₄ alkenyl, C₂-C₄ alkynyl, phenyl, and benzyl have the same properties or chemical structures as the hydrocarbon groups described above. In this context, substituted means that individual atoms or groups of atoms of the substituents R¹, R², R³, and R⁴ are replaced by the fluorine atom and/or by the chemical group.

Particularly high solubility of the first conductive salt in the SO₂-based electrolyte can be achieved if at least one of the substituents R¹, R², R³, and R⁴ is a CF₃ group or an OSO₂CF₃ group.

In one further advantageous refinement of the rechargeable battery cell, the first conductive salt is selected from the group formed by

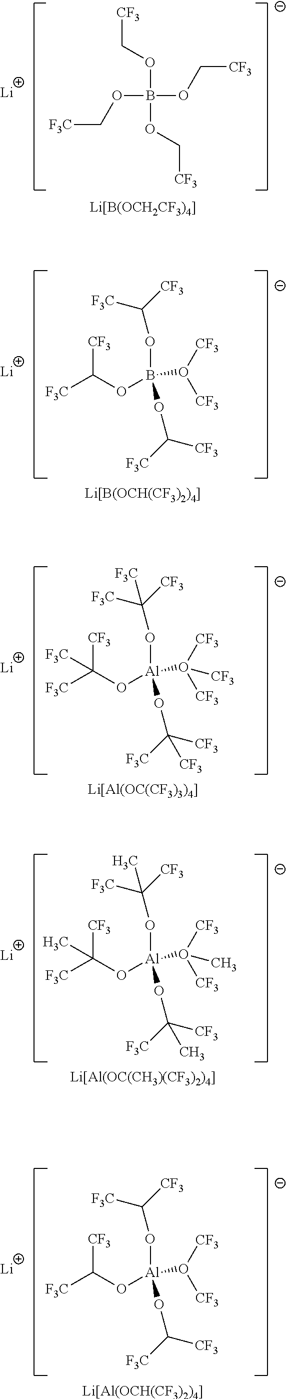

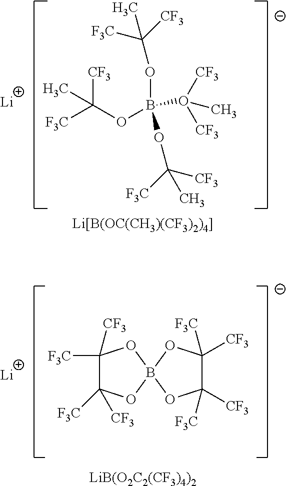

The last-mentioned first conductive salt with the empirical formula LiB(O₂C₂(CF₃)₄)₂ has two chelating ligands, each bidentate, with the following structure

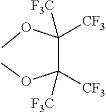 [SMILES: COC(C(F)(F)F)(C(F)(F)F)C(OC)(C(F)(F)F)C(F)(F)F]

which are coordinated to the central atom B³⁺ to form the chelate complex. For this purpose, two perfluorinated alkoxy substituents are bridged to one another via a CC single bond.

In order to adjust the conductivity and/or other properties of the electrolyte to a desired value, in one further advantageous embodiment of the inventive rechargeable battery cell the electrolyte has at least one second conductive salt which differs from the first conductive salt according to formula (I). This means that, in addition to the first conductive salt, the electrolyte can contain one or further second conductive salts which differ from the first conductive salt in terms of their chemical composition and their chemical structure.

In one further advantageous embodiment of the inventive rechargeable battery cell, the second conductive salt is an alkali metal compound, in particular a lithium compound. The alkali metal compound or the lithium compound is selected from the group formed by an aluminate, a halide, an oxalate, a borate, a phosphate, an arsenate and a gallate. The second conductive salt is preferably a lithium tetrahalogenoaluminate, in particular LiAlCl₄.

Furthermore, in one further advantageous embodiment of the inventive rechargeable battery cell, the electrolyte contains at least one additive. This additive is preferably selected from the group formed by vinylene carbonate and its derivatives, vinyl ethylene carbonate and its derivatives, methyl ethylene carbonate and its derivatives, lithium (bisoxalato)borate, lithium difluoro(oxalato)borate, lithium tetrafluoro(oxalato)phosphate, lithium oxalate, 2-vinylpyridine, 4-vinylpyridine, cyclic exomethylene carbonates, sulfones, cyclic and acyclic sulfonates, acyclic sulfites, cyclic and acyclic sulfinates, organic esters of inorganic acids, acyclic and cyclic alkanes, which acyclic and cyclic alkanes have a boiling point of at least 36° C. at 1 bar, aromatic compounds, halogenated cyclic and acyclic sulfonylimides, halogenated cyclic and acyclic phosphate esters, halogenated cyclic and acyclic phosphines, halogenated cyclic and acyclic phosphites, halogenated cyclic and acyclic phosphazenes, halogenated cyclic and acyclic silylamines, halogenated cyclic and acyclic halogenated esters, halogenated cyclic and acyclic amides, halogenated cyclic and acyclic anhydrides, and halogenated organic heterocycles.

In one further advantageous refinement of the rechargeable battery cell, the electrolyte has the following composition relative to the total weight of the electrolyte composition:
(i) 5 to 99.4 wt. % sulfur dioxide,
(ii) 0.6 to 95 wt. % of the first conductive salt,
(iii) 0 to 25 wt. % of the second conductive salt, and,
(iv) 0 to 10 wt. % of the additive.

As already mentioned above, the electrolyte can contain not only a first conductive salt according to formula (I) and a second conductive salt, but also a plurality of first conductive salts according to formula (I) and a plurality of second conductive salts. In the latter case, the aforementioned percentages also include a plurality of first conductive salts and a plurality of second conductive salts. The molar concentration of the first conductive salt is in the range of 0.01 mol/L to 10 mol/L, preferably 0.05 mol/L to 10 mol/L, more preferably 0.1 mol/L to 6 mol/L, and particularly preferably 0.2 mol/L to 3.5 mol/L based on the total volume of the electrolyte.

One further advantageous refinement of the inventive rechargeable battery cell provides that the electrolyte contains at least 0.1 mole SO₂, preferably at least 1 mole SO₂, more preferably at least 5 moles SO₂, more preferably at least 10 moles SO₂, and particularly preferably at least 20 moles SO₂ per mole of conductive salt. The electrolyte can also contain very high molar proportions of SO₂, the preferred upper limit being 2600 moles SO₂ per mole of conductive salt, and upper limits of 1500, 1000, 500 and 100 moles SO₂ per mole of conductive salt in this order being more preferred. The term “per mole of conductive salt” relates to all conductive salts contained in the electrolyte. SO₂-based electrolytes with such a concentration ratio between SO₂ and the conductive salt have the advantage that they can dissolve a larger amount of conductive salt compared to the electrolytes known from the prior art, which are based, for example, on an organic solvent mixture. Within the scope of this disclosure, it was found that, surprisingly, an electrolyte with a relatively low concentration of conductive salt is advantageous despite the associated higher vapor pressure, in particular with regard to its stability over many charging and discharging cycles of the rechargeable battery cell. The concentration of SO₂ in the electrolyte affects its conductivity. Thus, the selection of the SO₂ concentration can be used to adjust the conductivity of the electrolyte to the planned use of a rechargeable battery cell operated with this electrolyte.

The total content of SO₂ and the first conductive salt can be greater than 50 percent by weight (wt. %) of the weight of the electrolyte, preferably greater than 60 wt. %, more preferably greater than 70 wt. %, more preferably greater than 80 wt. %, more preferably greater than 85 wt. %, more preferably greater than 90 wt. %, more preferably greater than 95 wt. %, or more preferably greater than 99 wt. %.

The electrolyte can contain at least 5 wt. % SO₂ relative to the total amount of the electrolyte contained in the rechargeable battery cell, values of 20 wt. % SO₂, 40 wt. % SO₂, and 60 wt. % SO₂ being more preferred. The electrolyte can also contain up to 95 wt. % SO₂, maximum values of 80 wt. % SO₂ and 90 wt. % SO₂ in this order being preferred.

It is within the scope of this disclosure that the electrolyte preferably has only a small percentage or even no percentage of at least one organic solvent. The proportion of organic solvents in the electrolyte, which is present, for example, in the form of one or a mixture of a plurality of solvents, can preferably be at most 50 wt. % of the weight of the electrolyte. Lower proportions of at most 40 wt. %, at most 30 wt. %, at most 20 wt. %, at most 15 wt. %, at most 10 wt. %, at most 5 wt. %, or at most 1 wt. % of the weight of the electrolyte are particularly preferred. More preferably, the electrolyte is free of organic solvents. Due to the low proportion of organic solvents, or even their complete absence, the electrolyte is either hardly flammable or not at all flammable. This increases the operational reliability of a rechargeable battery cell operated with such an SO₂-based electrolyte. The SO₂-based electrolyte is particularly preferably essentially free of organic solvents.

In one further advantageous refinement of the rechargeable battery cell, the electrolyte has the following composition relative to the total weight of the electrolyte composition:
(i) 5 to 99.4 wt. % sulfur dioxide,
(ii) 0.6 to 95 wt. % of the first conductive salt,
(iii) 0 to 25 wt. % of the second conductive salt,
(iv) 0 to 10 wt. % of the additive, and,
(v) 0 to 50 wt. % of an organic solvent.

### Active Metal

Advantageous refinements of the inventive rechargeable battery cell with regard to the active metal are described below:

In one advantageous refinement of the rechargeable battery cell, the active metal is
an alkali metal, especially lithium or sodium;
an alkaline earth metal, especially calcium;
a metal from group 12 of the periodic table, in particular zinc; or,
aluminum.

### Positive Electrode

Advantageous refinements of the inventive rechargeable battery cell with regard to the positive electrode are described below:

A first advantageous refinement of the inventive rechargeable battery cell provides that the positive electrode is chargeable up to an upper potential of 4.0 volts, preferably up to a potential of 4.4 volts, more preferably at least a potential of 4.8 volts, more preferably at least up to a potential of 5.2 volts, more preferably at least up to a potential of 5.6 volts, and particularly preferably at least up to a potential of 6.0 volts.

In one further advantageous refinement of the inventive rechargeable battery cell, the positive electrode contains at least one active material. This active material can store ions of the active metal and during operation of the battery cell can release and take up the ions of the active metal again.

In one further advantageous refinement of the inventive rechargeable battery cell, the positive electrode contains at least one intercalation compound. In the context of this disclosure, the term “intercalation compound” is understood to mean a subcategory of the insertion materials described above. This intercalation compound acts as a host matrix that has interconnected vacancies. The ions of the active metal can diffuse into these vacancies during the discharge process of the rechargeable battery cell and be intercalated there. Little or no structural changes occur in the host matrix as a result of this intercalation of the active metal ions.

In one further advantageous refinement of the inventive rechargeable battery cell, the positive electrode contains at least one conversion compound as the active material. In the context of this disclosure, the term “conversion compounds” is understood to mean materials that form other materials during electrochemical activity; i.e., chemical bonds are broken and re-formed during the charging and discharging of the battery cell. Structural changes occur in the matrix of the conversion compound during the taking up or release of the active metal ions.

In one further advantageous refinement of the inventive rechargeable battery cell, the active material has the composition AₓM′_{y}M″_{z}Oₐ.

In this composition AₓM′_{y}M″_{z}Oₐ:
A is at least one metal selected from the group formed by the alkali metals, alkaline earth metals, metals of group 12 of the periodic table, or aluminum;
M′ is at least one metal selected from the group formed by the elements Ti, V, Cr, Mn, Fe, Co, Ni, Cu, and Zn;
M″ is at least one element selected from the group formed by the elements of groups 2, 3, 4, 5, 6, 7, 8, 9, 10, 11, 12, 13, 14, 15 and 16 of the periodic table of elements;
x and y, independently of one another, are numbers greater than 0;
z is a number greater than or equal to 0; and,
a is a number greater than 0.

A is preferably the metal lithium, i.e., the compound may have the composition LiₓM′_{y}M″_{z}Oₐ.

The indices y and z in the composition AₓM′_{y}M″_{z}Oₐ refer to all of the metals and elements that are represented by M′ and M″. For example, if M′ includes two metals M′¹ and M′², then the following applies to the index y: y=y1+y2, where y1 and y2 represent the indices of the metals M′¹ and M′². The indices x, y, z, and a must be selected in such a way that there is charge neutrality within the composition. Examples of compounds in which M′ includes two metals are lithium nickel manganese cobalt oxides of the composition LiₓNi_{y1}Mn_{y2}Co_{z}O₂ with M′¹=Ni, M′²=Mn, and M″=Co. Examples of compounds in which z=0, that is, which have no further metal or element M″, are lithium cobalt oxides LiₓCo_{y}Oₐ. For example, if M″ includes two elements, a metal M″¹ on the one hand and phosphorus as M″² on the other hand, the following applies to the index z: z=z1+z2, where z1 and z2 are the indices of the metal M″¹ and phosphorus (M″²). The indices x, y, z, and a must be selected in such a way that there is charge neutrality within the composition. Examples of compounds in which A includes lithium, M″ includes a metal M″¹, and phosphorus as M″² are lithium iron manganese phosphates LiₓFe_{y}Mn_{z1}P_{z2}O₄ with A=Li, M′=Fe, M″¹=Mn, and M″²=P and z2=1. In one further composition, M″ may include two non-metals, for example, fluorine as M″¹ and sulfur as M″². Examples of such compounds are lithium iron fluorosulfates LiₓFe_{y}F_{z1}S_{z2}O₄ where A=Li, M′=Fe, M″₁=F, and M″₂=P.

One further advantageous refinement of the inventive rechargeable battery cell provides that M′ comprises the metals nickel and manganese and M″ is cobalt. These can be compositions of the formula LiₓNi_{y1}Mn_{y2}Co_{z}O₂ (NMC), i.e., lithium nickel manganese cobalt oxides which have the structure of layered oxides. Examples of these lithium nickel manganese cobalt oxide active materials are LiNi_{1/3}Mn_{1/3}Co_{1/3}O₂ (NMC111), LiNi_{0.6}Mn_{0.2}Co_{0.2}O₂ (NMC622), and LiNi_{0.8}Mn_{0.1}Co_{0.1}O₂ (NMC811). Further compounds of lithium nickel manganese cobalt oxide can have the composition LiNi_{0.5}Mn_{0.3}Co_{0.2}O₂, LiNi_{0.5}Mn_{0.25}Co_{0.25}O₂, LiNi_{0.52}Mn_{0.32}Co_{0.16}O₂, LiNi_{0.55}Mn_{0.30}Co_{0.15}O₂, LiNi_{0.58}Mn_{0.14}Co_{0.28}O₂, LiNi_{0.64}Mn_{0.18}Co_{0.18}O₂, LiNi_{0.65}Mn_{0.27}Co_{0.08}O₂, LiNi_{0.7}Mn_{0.2}Co_{0.1}O₂, LiNi_{0.7}Mn_{0.15}Co_{0.15}O₂, LiNi_{0.72}Mn_{0.10}Co_{0.18}O₂, LiNi_{0.76}Mn_{0.14}Co_{0.10}O₂, LiNi_{0.86}Mn_{0.04}Co_{0.10}O₂, LiNi_{0.90}Mn_{0.05}Co_{0.05}O₂, LiNi_{0.95}Mn_{0.025}Co_{0.025}O₂, or a combination thereof. With these compounds it is possible to produce positive electrodes for rechargeable battery cells with a cell voltage of over 4.6 volts.

One further advantageous refinement of the inventive rechargeable battery cell provides that the active material is a metal oxide which is rich in lithium and manganese (Lithium and Manganese Rich Oxide Material). This metal oxide can have the composition LiₓMn_{y}M″_{z}Oₐ. M′ thus represents the metal manganese (Mn) in the formula LiₓM′_{y}M″_{z}Oₐ described above. The index x is greater than or equal to 1 here, the index y is greater than the index z or greater than the sum of the indices z1+z2+z3, etc. For example, if M″ includes two metals M″¹ and M″² with the indices z1 and z2 (e.g., Li_{1.2}Mn_{0.525}Ni_{0.175}Co_{0.1}O₂ with M″¹=Ni z1=0.175 and M″²=Co z2=0.1), then for the index y:y>z1+z2. The index z is greater than or equal to 0 and the index a is greater than 0. The indices x, y, z, and a must be selected in such a way that there is charge neutrality within the composition. Metal oxides rich in lithium and manganese can also be described by the formula mLi₂MnO₃·(1−m)LiM′O₂ where 0<m<1. Examples of such compounds are Li_{1.2}Mn_{0.525}Ni_{0.175}Co_{0.1}O₂, Li_{1.2}Mn_{0.6}Ni_{0.2}O₂ or Li_{1.2}Ni_{0.13}Co_{0.13}Mn_{0.54}O₂.

One further advantageous refinement of the inventive rechargeable battery cell provides that the composition has the formula AₓM′_{y} M″_{z}O₄. These compounds are spinel structures. For example, A can be lithium, M′ can be cobalt, and M″ can be manganese. In this case, the active material is lithium cobalt manganese oxide (LiCoMnO₄). LiCoMnO₄ can be used to produce positive electrodes for rechargeable battery cells with a cell voltage of over 4.6 volts. This LiCoMnO₄ is preferably Mn³⁺-free. In a further example, M′ may be nickel and M″ may be manganese. In this case, the active material is lithium nickel manganese oxide (LiNiMnO₄). The molar proportions of the two metals M′ and M″ can vary. For example, lithium nickel manganese oxide may have the composition LiNi_{0.5}Mn_{1.5}O₄.

In one further advantageous refinement of the inventive rechargeable battery cell, the positive electrode contains as the active material at least one active material, which represents a conversion compound. Conversion compounds undergo a solid-state redox reaction during the uptake of the active metal, e.g., lithium or sodium, in which the crystal structure of the material changes. This occurs with the breaking and recombination of chemical bonds. Completely reversible reactions of conversion compounds can be, e.g., as follows:

Type A: MX_{z}+y Li⇄M+z Li_{(y/z)}X

### Type B: X+y Li⇄Li_{y}X

Examples of conversion compounds are FeF₂, FeF₃, CoF₂, CuF₂, NiF₂, BiF₃, FeCl₃, FeCl₂, CoCl₂, NiCl₂, CuCl₂, AgCl, LiCl, S, Li₂S, Se, Li₂Se, Te, I, and LiI.

In one further advantageous refinement, the compound has the composition AₓM′_{y}M″¹_{z1}M″²_{z2}O₄, where M″¹ is selected from the group formed by the elements of groups 2, 3, 4, 5, 6, 7, 8, 9, 10, 11, 12, 13, 14, 15, and 16 of the periodic table of the elements, M″² is the element phosphorus, x and y are independently numbers greater than 0, z1 is a number greater than 0, and z2 has the value 1. The compound with the composition AₓM′_{y}M″¹_{z1}M″²_{z2}O₄ is a so-called lithium metal phosphate. In particular, this compound has the composition LiₓFe_{y}Mn_{z1}P_{z2}O₄. Examples of lithium metal phosphates are lithium iron phosphate (LiFePO₄) or lithium iron manganese phosphates (Li(Fe_{y}Mn_{z})PO₄). An example of a lithium iron manganese phosphate is the phosphate of the composition Li(Fe_{0.3}Mn0.7)PO₄. An example of a lithium iron manganese phosphate is the phosphate with the composition Li(Fe_{0.3}Mn_{0.7})PO₄. Lithium metal phosphates with other compositions can also be used for the inventive battery cell.

One further advantageous refinement of the inventive rechargeable battery cell provides that the positive electrode contains at least one metal compound. This metal compound is selected from the group formed by a metal oxide, a metal halide and a metal phosphate. The metal of this metal compound is preferably a transition metal with atomic numbers 22 to 28 in the periodic table of elements, in particular cobalt, nickel, manganese, or iron.

One further advantageous refinement of the inventive rechargeable battery cell provides that the positive electrode contains at least one metal compound which has the chemical structure of a spinel, a layered oxide, a conversion compound, or a polyanionic compound.

It is within the scope of this disclosure that the positive electrode contains as active material at least one of the compounds described or a combination of the compounds. A combination of the compounds means a positive electrode which contains at least two of the materials described.

In one further advantageous refinement of the inventive battery cell, the positive electrode has at least one binding agent. This binding agent is preferably a fluorinated binding agent, in particular a polyvinylidene fluoride and/or a terpolymer formed from tetrafluoroethylene, hexafluoropropylene, and vinylidene fluoride. However, it can also be a binding agent which comprises a polymer built up from monomeric structural units of a conjugated carboxylic acid or from the alkali metal, alkaline earth metal, or ammonium salt of this conjugated carboxylic acid or from a combination thereof. Furthermore, the binding agent can also comprise a polymer based on monomeric styrene and butadiene structural units. In addition, the binding agent can also be a binding agent from the group of carboxymethyl celluloses. The binding agent is in the positive electrode preferably in a concentration of at most 20 wt. %, more preferably at most 15 wt. %, more preferably at most 10 wt. %, more preferably at most 7 wt. %, more preferably at most 5 wt. %, and particularly preferably at most 2 wt. % based on the total weight of the positive electrode.

### Negative Electrode

Advantageous refinements of the inventive rechargeable battery cell with regard to the negative electrode are described below:

One further advantageous refinement of the rechargeable battery cell provides that the negative electrode is an insertion electrode. This insertion electrode contains an insertion material as an active material into which the active metal ions can be intercalated during the charging of the rechargeable battery cell and from which the active metal ions can be deintercalated during the discharging of the rechargeable battery cell. This means that the electrode processes can take place not only on the surface of the negative electrode, but also within the negative electrode. If, for example, a lithium-based conductive salt is used, lithium ions can be intercalated into the insertion material during the charging of the rechargeable battery cell and deintercalated from it during the discharging of the rechargeable battery cell. The negative electrode preferably contains carbon as the active material or insertion material, in particular in the graphite modification. However, it is also within the scope of this disclosure for the carbon to be in the form of natural graphite (flake promoter or rounded), synthetic graphite (mesophase graphite), graphitized MesoCarbon MicroBeads (MCMB), carbon-coated graphite, or amorphous carbon.

In one further advantageous refinement of the inventive rechargeable battery cell, the negative electrode includes lithium intercalation anode active materials which do not contain any carbon, for example, lithium titanates (e.g., Li₄Ti₅O₁₂).

One further advantageous refinement of the inventive rechargeable battery cell provides that the negative electrode includes active anode materials which form alloys with lithium. These are, for example, lithium-storing metals and metal alloys (e.g., Si, Ge, Sn, SnCoₓC₆, SnSiₓ, and the like), and oxides of lithium-storing metals and metal alloys (e.g., SnOₓ, SiOₓ, oxidic glasses of Sn, Si, and the like).

In one further advantageous refinement of the inventive rechargeable battery cell, the negative electrode contains conversion anode active materials. These conversion anode active materials can be, for example, transition metal oxides in the form of manganese oxides (MnOₓ), iron oxides (FeOₓ), cobalt oxides (CoOₓ), nickel oxides (NiOₓ), copper oxides (CuOₓ), or metal hydrides in the form of magnesium hydride (MgH₂), titanium hydride (TiH₂), aluminum hydride (AlH₃), and boron, aluminum and magnesium-based ternary hydrides and the like.

In one further advantageous refinement of the inventive rechargeable battery cell, the negative electrode includes a metal, in particular metallic lithium.

One further advantageous refinement of the inventive rechargeable battery cell provides that the negative electrode is porous, the porosity preferably being at most 50%, more preferably at most 45%, more preferably at most 40%, more preferably at most 35%, more preferably at most 30%, more preferably at most 20%, and particularly preferably at most 10%. The porosity represents the void volume in relation to the total volume of the negative electrode, the void volume being formed by so-called pores or cavities. This porosity increases the internal surface area of the negative electrode. Furthermore, the porosity reduces the density of the negative electrode and thus also its weight. The individual pores of the negative electrode can preferably be completely filled with the electrolyte during operation.

In one further advantageous refinement of the inventive battery cell, the negative electrode has at least one binding agent. This binding agent is preferably a fluorinated binding agent, in particular a polyvinylidene fluoride and/or a terpolymer formed from tetrafluoroethylene, hexafluoropropylene, and vinylidene fluoride. However, it can also be a binding agent which comprises a polymer built up from monomeric structural units of a conjugated carboxylic acid or from the alkali metal, alkaline earth metal, or ammonium salt of this conjugated carboxylic acid or from a combination thereof. Furthermore, the binding agent can also comprise a polymer based on monomeric styrene and butadiene structural units. In addition, the binding agent can also be a binding agent from the group of carboxymethyl celluloses. The binding agent is in the negative electrode preferably in a concentration of at most 20 wt. %, more preferably at most 15 wt. %, more preferably at most 10 wt. %, more preferably at most 7 wt. %, more preferably at most 5 wt. %, and particularly preferably at most 2 wt. % based on the total weight of the negative electrode.

In one further advantageous refinement of the inventive battery cell, the negative electrode has at least one conductivity additive. The conductivity additive should preferably have a low weight, high chemical resistance, and a high specific surface area. Examples of conductivity additives are particulate carbon (carbon black, Super P, acetylene black), fibrous carbon (carbon nanotubes CNT, carbon (nano)fibers), finely divided graphite, and graphene (nanosheets).

### Structure of the Rechargeable Battery Cell

Advantageous refinements of the inventive rechargeable battery cell are described below with regard to their structure:

In order to further improve the function of the rechargeable battery cell, one further advantageous refinement of the inventive rechargeable battery cell provides that the rechargeable battery cell includes a plurality of negative electrodes and a plurality of positive electrodes which are arranged in the housing in an alternating stack. In this case, the positive electrodes and the negative electrodes are preferably each electrically separated from one another by separators.

However, the rechargeable battery cell can also be designed as a wound cell in which the electrodes comprise thin layers that are wound up together with a separator material. On the one hand, the separators separate the positive electrode and the negative electrode spatially and electrically and, on the other hand, they are permeable, inter alia, to the ions of the active metal. In this way, large electrochemically active surfaces are created which enable a correspondingly high current yield.

The separator can be formed from a fleece, membrane, web, knitted fabric, organic material, inorganic material, or combination thereof. Organic separators can comprise unsubstituted polyolefins (e.g., polypropylene or polyethylene), partially to fully halogen-substituted polyolefins (e.g., partially to fully fluorine-substituted, in particular PVDF, ETFE, PTFE), polyesters, polyamides or polysulfones. Separators containing a combination of organic and inorganic materials are, for example, glass fiber fabrics in which the glass fibers are provided with a suitable polymer coating. The coating preferably contains a fluorine-containing polymer such as, for example, polytetrafluoroethylene (PTFE), ethylene tetrafluoroethylene (ETFE), perfluoroethylene propylene (FEP), THV (terpolymer of tetrafluoroethylene, hexafluoroethylene, and vinylidene fluoride), a perfluoroalkoxy polymer (PFA), aminosilane, polypropylene, or polyethylene (PE). The separator can also be folded in the housing of the rechargeable battery cell, for example, in the form of a so-called “Z-folding.” In the case of this Z-folding, a strip-shaped separator is folded in a Z-like manner through or around the electrodes. Furthermore, the separator can also be embodied as separator paper.

It is also within the scope of this disclosure for the separator to be in the form of a covering, each positive electrode or each negative electrode being enclosed by the covering. The covering can be embodied from a fleece, membrane, web, knitted fabric, organic material, inorganic material, or combination thereof.

Enclosing the positive electrode results in more uniform ion migration and ion distribution in the rechargeable battery cell. The more uniform the ion distribution, in particular in the negative electrode, the higher the possible loading of the negative electrode with active material can be, and consequently the usable capacity of the rechargeable battery cell. At the same time, risks that can be associated with uneven loading, and the resulting deposition of the active metal, are avoided. These advantages have an effect especially when the positive electrodes of the rechargeable battery cell are enclosed with the covering.

The surface area dimensions of the electrodes and the covering can preferably be matched to one another in such a way that the outer dimensions of the covering of the electrodes and the outer dimensions of the noncovered electrodes match at least in one dimension.

The surface area of the covering can preferably be greater than the surface area of the electrode. In this case, the covering extends beyond a limit of the electrode. Two layers of the covering enclosing the electrode on both sides can therefore be connected to one another at the edge of the positive electrode by an edge connection.

In one further advantageous refinement of the inventive rechargeable battery cell, the negative electrodes have a covering, while the positive electrodes have no covering.

Further advantageous properties of this disclosure are described and explained in more detail below using figures, examples, and experiments.

### BRIEF DESCRIPTION OF THE DRAWINGS

The above-mentioned aspects of exemplary embodiments will become more apparent and will be better understood by reference to the following description of the embodiments taken in conjunction with the accompanying drawings, wherein:

FIG. 1 is a sectional view of a first exemplary embodiment of an inventive rechargeable battery cell;

FIG. 2 is a detail from an electron micrograph of the three-dimensional porous structure of the metal foam of the first exemplary embodiment from FIG. 1;

FIG. 3 is a sectional view of a second exemplary embodiment of an inventive rechargeable battery cell;

FIG. 4 shows a detail of the second exemplary embodiment from FIG. 3;

FIG. 5 is an exploded view of a third embodiment of the inventive rechargeable battery cell;

FIG. 6 shows the potential in [V] of two test full cells with graphite electrodes with copper or nickel discharge elements, which were filled with the reference electrolyte from Example 1, during charging as a function of the capacity, which is related to the theoretical capacity of the negative electrode, during a top layer formation on the negative electrode;

FIG. 7 shows the discharge capacity as a function of the number of cycles of two test full cells with graphite electrodes with copper or nickel discharge elements, the test full cells being filled with the reference electrolyte;

FIG. 8 shows the potential in [V] of two test full cells with graphite electrodes with copper or nickel discharge element, which were filled with electrolyte 1, during charging as a function of the capacity, which is related to the theoretical capacity of the negative electrode, during a top layer formation on the negative electrode;

FIG. 9 shows the discharge capacity as a function of the number of cycles of two test full cells with graphite electrodes with copper or nickel discharge elements, the test full cells being filled with electrolyte 1;

FIG. 10 shows a photograph of the copper discharge element after the measurement from FIG. 9;

FIG. 11 shows the course of the potential during charging and discharging in volts as a function of the percentage charge of a cycle of a half-cell with a graphite electrode with a copper discharge element, the half-cell being filled with electrolyte 5;

FIG. 12 shows the potential and current strength as a function of time in half-cells with an aluminum discharge element, the half-cells being filled either with the reference electrolyte or with electrolyte 1;

FIG. 13 shows an aluminum discharge element before the experiment in the half-cell with reference electrolyte from FIG. 12;

FIG. 14 shows the aluminum discharge element after the experiment in the half-cell with reference electrolyte from FIG. 12;

FIG. 15 shows the aluminum discharge element after the experiment in the half-cell with electrolyte 1 from FIG. 12;

FIG. 16 shows the course of the potential during charging and discharging in volts as a function of the percentage charge of the first cycle of a half-cell with a positive electrode with an aluminum discharge element, the half-cell being filled with electrolyte 1;

FIG. 17 shows the discharge capacity as a function of the number of cycles of a test full cell with a positive electrode with an aluminum discharge element, the test full cell being filled with electrolyte 1;

FIG. 18 shows the discharge capacities as a function of the number of cycles of two full cells with positive electrodes with an aluminum discharge element and negative electrodes with a copper discharge element, the full cells being filled with electrolyte 1 and the end-of-charge voltage being 4.3 or 4.6 volts;

FIG. 19 shows the course of the potential during charging and discharging in volts as a function of the percentage charge of the first cycle of a half-cell with a positive electrode with an aluminum discharge element, the half-cell being filled with electrolyte 5;

FIG. 20 shows the potential in [V] of three test full cells, which were filled with electrolytes 1 and 3 from Example 2 and the reference electrolyte from Example 1, when charging a negative electrode as a function of the capacity, which is related to the theoretical capacity of the negative electrode, during top layer formation on the negative electrode;

FIG. 21 shows the course of the potential during discharge in volts as a function of the percentage charge of four test full cells which were filled with electrolytes 1, 3, 4, and 5 from Example 2 and contained lithium nickel manganese cobalt oxide (NMC) as the active electrode material;

FIG. 22 shows the conductivities in [mS/cm] of electrolytes 1, 4, and 6 from Example 2 as a function of the concentration of compounds 1, 4, and 6; and

FIG. 23 shows the conductivities in [mS/cm] of electrolytes 3 and 5 from Example 2 as a function of the concentration of compounds 3 and 5.

### DESCRIPTION

The embodiments described below are not intended to be exhaustive or to limit the invention to the precise forms disclosed in the following detailed description. Rather, the embodiments are chosen and described so that others skilled in the art may appreciate and understand the principles and practices of this disclosure.

It shall be understood for purposes of this disclosure and appended claims that, regardless of whether the phrases “one or more” or “at least one” precede an element or feature appearing in this disclosure or claims, such element or feature shall not receive a singular interpretation unless it is made explicit herein. By way of non-limiting example, the terms “positive electrode,” “negative electrode,” “conductive salt,” and “binder,” to name just a few, should be interpreted wherever they appear in this disclosure and claims to mean “at least one” or “one or more” regardless of whether they are introduced with the expressions “at least one” or “one or more.” All other terms used herein should be similarly interpreted unless it is made explicit that a singular interpretation is intended.

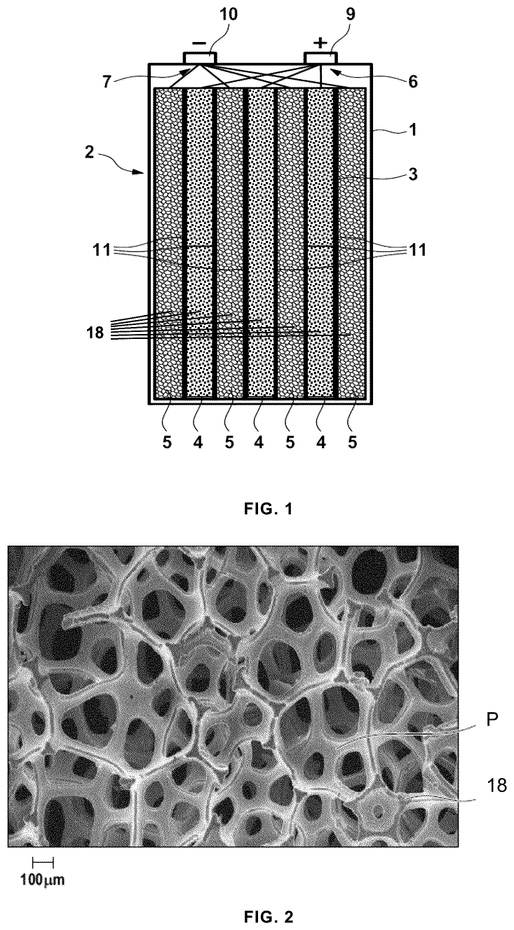

FIG. 1 is a sectional view of a first exemplary embodiment of an inventive rechargeable battery cell 2. This rechargeable battery cell 2 is designed as a prismatic cell and has a housing 1, inter alia. This housing 1 encloses an electrode arrangement 3 which includes three positive electrodes 4 and four negative electrodes 5. The positive electrodes 4 and the negative electrodes 5 are stacked alternately in the electrode assembly 3. However, the housing 1 can also accommodate more positive electrodes 4 and/or negative electrodes 5. It is generally preferred for the number of negative electrodes 5 to be greater by one than the number of positive electrodes 4. As a result, the outer end faces of the electrode stack are formed by the electrode surfaces of the negative electrodes 5. The electrodes 4, 5 are connected to corresponding connection contacts 9, 10 of the rechargeable battery cell 2 via electrode connections 6, 7. The rechargeable battery cell 2 is filled with an SO₂-based electrolyte in such a way that the electrolyte penetrates as completely as possible into all the pores or cavities, in particular within the electrodes 4, 5. The electrolyte is not visible in FIG. 1. In the present exemplary embodiment, the positive electrodes 4 contain an intercalation compound as active material. This intercalation compound is LiCoMnO4 with a spinel structure. In the present exemplary embodiment, the electrodes 4, 5 are embodied flat, i.e., as layers with a smaller thickness in relation to the extension of their surface. They are each separated from one another by separators 11. The housing 1 of the rechargeable battery cell 2 is essentially cuboid, the electrodes 4, 5 and the walls of the housing 1 shown in a sectional view extending perpendicular to the plane of the drawing and being shaped essentially straight and flat. However, the rechargeable battery cell 2 can also be designed as a wound cell in which the electrodes comprise thin layers that are wound up together with a separator material. The separators 11 on the one hand separate the positive electrode 4 and the negative electrode 5 spatially and electrically and on the other hand are permeable, inter alia, to the ions of the active metal. In this way, large electrochemically active surfaces are created which enable a correspondingly high current yield. The electrodes 4, 5 also each have a discharge element which enables the required electronically conductive connection of the active material of the respective electrode. This discharge element is in contact with the active material involved in the electrode reaction of the respective electrode 4, 5 (not shown in FIG. 1). The discharge elements are in the form of a porous metal foam 18. The metal foam 18 extends across the thickness of the electrodes 4, 5. The active material of the positive electrodes 4 and negative electrodes 5 is incorporated into the pores of this metal foam 18 so that it evenly fills the pores of the latter over the entire thickness of the metal structure. To improve the mechanical strength, the positive electrodes 4 contain a binding agent. This binding agent is a fluoropolymer. The negative electrodes 5 contain carbon as an active material in a form suitable as an insertion material for taking up lithium ions. The structure of the negative electrode 5 is similar to that of the positive electrode 4. In the present first exemplary embodiment, a discharge element of the positive electrode 4 is made of aluminum and a discharge element of the negative electrode 5 is made of copper.

FIG. 2 shows an electron micrograph of the three-dimensional porous structure of the metal foam 18 of the first exemplary embodiment from FIG. 1. The scale indicated shows that the pores P have an average diameter of more than 100 μm, that is, they are relatively large.

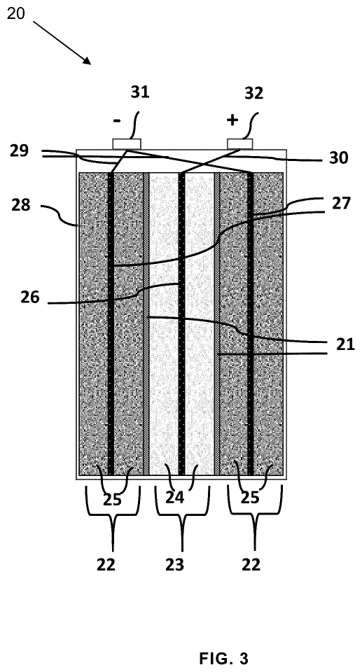

FIG. 3 is a sectional view of a second exemplary embodiment of an inventive rechargeable battery cell 20. This second exemplary embodiment is distinguished from the first embodiment shown in FIG. 1 in that the electrode arrangement includes one positive electrode 23 and two negative electrodes 22. They are each separated from one another by separators 21 and enclosed by a housing 28. The positive electrode 23 has a discharge element 26 in the form of a planar metal film to which the active material 24 of the positive electrode 23 is applied on both sides. The negative electrodes 22 also include a second discharge element 27 in the form of a planar metal film to which the active material 25 of the negative electrode 22 is applied on both sides. Alternatively, the planar discharge elements of the edge electrodes, that is to say the electrodes which close off the electrode stack, can be coated with active material on only one side. The non-coated side faces the wall of the housing 28. The electrodes 22, 23 are connected to corresponding connection contacts 31, 32 of the rechargeable battery cell 20 via electrode connections 29, 30.

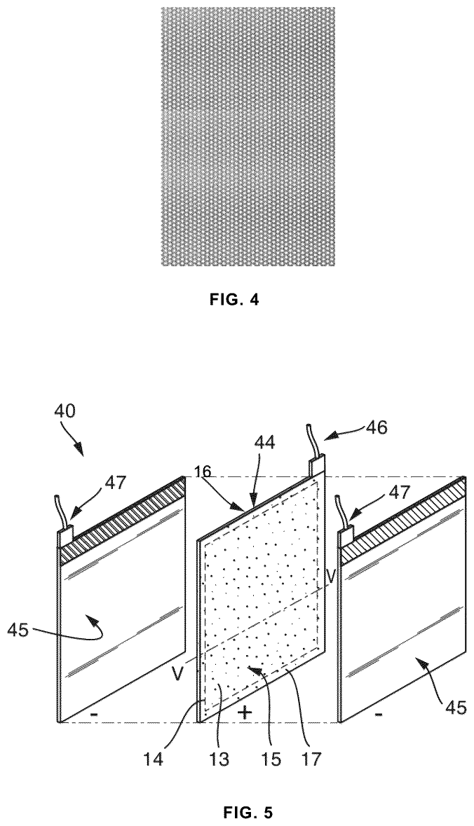

FIG. 4 shows the planar metal film, which serves as a discharge element 26, 27 for the positive electrodes 23 and the negative electrodes 22 in the second exemplary embodiment from FIG. 3. This metal film has a perforated or net-like structure with a thickness of 20 μm.

FIG. 5 shows an exploded view of a third exemplary embodiment of an inventive rechargeable battery cell 40. This third exemplary embodiment is distinguished from the two exemplary embodiments explained above in that the positive electrode 44 is enclosed by a covering 13. In this case, a surface extension of the covering 13 is greater than a surface extension of the positive electrode 44, the limit 14 of which is drawn in as a dashed line in FIG. 5. Two layers 15, 16 of the covering 13 covering the positive electrode 44 on both sides are connected to one another by an edge connection 17 at the peripheral edge of the positive electrode 44. The two negative electrodes 45 are not enclosed. The electrodes 44 and 45 can be contacted via the electrode connections 46 and 47.

### EXAMPLE 1

### Preparation of a Reference Electrolyte

A reference electrolyte used for the examples described below was produced according to the method described in patent specification EP 2 954 588 B1 (hereinafter referred to as [V6]). First, lithium chloride (LiCl) was dried under vacuum at 120° C. for three days. Aluminum particles (Al) were dried under vacuum at 450° C. for two days. LiCl, aluminum chloride (AlCl₃) and Al were mixed together in an AlCl₃:LiCl:Al molar ratio of 1:1.06:0.35 in a glass bottle with an opening allowing gas to escape. Then, this mixture was heat-treated in stages to prepare a molten salt. After cooling, the molten salt formed was filtered, then cooled to room temperature, and finally SO₂ was added until the desired molar ratio of SO₂ to LiAlCl₄ was obtained. The reference electrolyte formed in this way had the composition LiAlCl₄*x SO₂, where x is a function of the amount of SO₂ supplied.

### EXAMPLE 2

### Production of Six Exemplary Embodiments 1, 2, 3, 4, 5, and 6 of an SO₂-Based Electrolyte for a Battery Cell

For the experiments described below, six exemplary embodiments 1, 2, 3, 4, 5, and 6 of the SO₂-based electrolyte (hereinafter referred to as electrolytes 1, 2, 3, 4, 5, and 6) were prepared. For this purpose, five different first conductive salts according to formula (I) were first produced according to a production process described in the following documents [V7], [V8], and [V9]:

[V7] “I. Krossing, Chem. Euro J. 2001, 7, 490;

[V8] S. M. Ivanova et al., Chem. Euro J. 2001, 7, 503;

[V9] Tsujioka et al., J. Electrochem. Soc., 2004, 151, A1418”

These six different, first conductive salts according to formula (I) are referred to below as compounds 1, 2, 3, 4, 5, and 6. They come from the family of polyfluoroalkoxyaluminates and were prepared in hexane according to the following reaction equation starting from LiAlH₄ and the corresponding alcohol R—OH with R¹=R²=R³=R⁴.

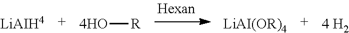

Chelate complexes were produced starting from the corresponding HO—R—OH diol according to a preparation method described in the following document [V10]:

[V10] Wu Xu et al., Electrochem. Solid State Lett. 2000, 3, 366-368.

This formed the compounds 1, 2, 3, 4, 5, and 6 shown below with the empirical or structural formulas:

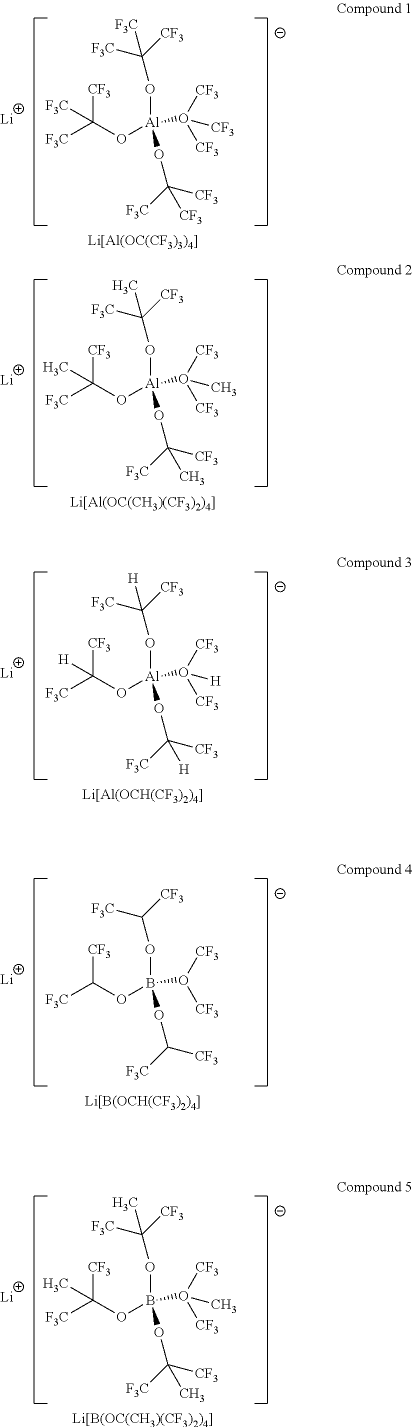

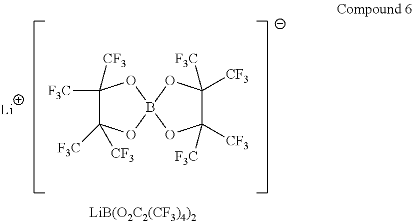

For purification, compounds 1, 2, 3, 4, 5, and 6 were first recrystallized. In this way, residues of the starting material LiAlH₄ were removed from the first conductive salt, since this starting material could possibly lead to sparking with any traces of water present in SO₂.

Then compounds 1, 2, 3, 4, 5, and 6 were dissolved in SO₂. It was found that compounds 1, 2, 3, 4, 5, and 6 dissolve well in SO₂.

The preparation of electrolytes 1, 2, 3, 4, 5, and 6 was carried out at low temperature or under pressure according to the process steps 1 to 4 listed below:
1) Provision of compounds 1, 2, 3, 4, 5, and 6, each in a pressure piston with riser pipe;
2) Evacuation of the pressure pistons;
3) Addition of liquid SO₂; and
4) Repetition of steps 2+3 until the target amount of SO₂ has been added.

The concentration of compounds 1, 2, 3, 4, 5, and 6 in electrolytes 1, 2, 3, 4, 5, and 6 was 0.6 mol/L (molar concentration based on 1 liter of the electrolyte), unless otherwise stated in the experiment description. The experiments described below were carried out with electrolytes 1, 2, 3, 4, 5, and 6 and the reference electrolyte.

### EXAMPLE 3

### Production of Test Full Cells

The test full cells used in the experiments described below are rechargeable battery cells with two negative electrodes and one positive electrode, each separated by a separator. The positive electrodes had an active material, a conductivity unit, a binding agent, and a discharge element. The active material of the positive electrode is identified in each experiment. The negative electrodes contained graphite as active material, a binding agent, and also a discharge element. If mentioned in the experiment, the negative electrodes can also contain a conductivity additive. The materials of the discharge elements of the positive and negative electrodes are aluminum and copper and are identified in each experiment. The discharge material nickel is used as a reference material from the prior art. Among other things, the goal of the investigations is to confirm the use of the discharge materials aluminum and copper for the positive electrode and the negative electrode in an inventive battery cell. Table 3 shows which tests were carried out with the various discharge materials.

The test full cells were each filled with the electrolyte required for the experiments, i.e., either with the reference electrolyte or with electrolytes 1, 2, 3, 4, 5, or 6. A plurality of identical test full cells, i.e., two to four, were produced for each experiment. The results presented in the experiments are in each case mean values from the measured values obtained for the identical test full cells.

### EXAMPLE 4

### Measurement in Test Full Cells

### Top Layer Capacity:

The capacity consumed in the first cycle for the formation of a top layer on the negative electrode is an important criterion for the quality of a battery cell. This top layer is formed on the negative electrode when the test full cell is first charged. For this top layer formation, lithium ions are irreversibly consumed (top layer capacity), so that the test full cell has less cycleable capacity for the subsequent cycles. The top layer capacity in % of theoretical, which was used to form the top layer on the negative electrode, is calculated using the following formula:

Top layer capacity [in % of theoretical]=(Q_{lad}(x mAh)−Qₑₙₜ(y mAh))/Q_{NEL}

Q_{lad} describes the amount of charge specified in the respective experiment in mAh; Qₑₙₜ describes the amount of charge in mAh that was obtained when the test full cell was subsequently discharged. Q_{NEL} is the theoretical capacity of the negative electrode used. In the case of graphite, for example, the theoretical capacity is calculated to be 372 mAh/g.

### Discharge Capacity:

For measurements in test full cells, e.g., the discharge capacity is determined using the number of cycles. To this end, the test full cells are charged with a specific charging current up to a specific upper potential. The corresponding upper potential is maintained until the charging current has dropped to a specific value. Thereafter, the discharge takes place with a specific discharge current intensity up to a specific discharge potential. This charging method is referred to as an I/U charge. This process is repeated depending on the desired number of cycles.

The upper potentials or the discharge potential and the respective charging or discharging currents are identified in the experiments. The value to which the charging current must have dropped is also described in the experiments.

The term “upper potential” is used synonymously with the terms “charging potential,” “charging voltage,” “end-of-charge voltage,” and “upper potential limit.” The terms refer to the voltage/potential to which a cell or battery is charged using a battery charger.

The battery is preferably charged at a current rate of C/2 and at a temperature of 22° C.

The term “discharge potential” is used synonymously with the term “lower cell voltage.” This is the voltage/potential to which a cell or battery is discharged using a battery charger.

The battery is preferably discharged at a current rate of C/2 and at a temperature of 22° C.

The discharge capacity is obtained from the discharge current and the time until the discharge termination criteria are met. The associated figures show mean values for the discharge capacities as a function of the number of cycles. These mean values of the discharge capacities are often normalized to 100% of the starting capacity and expressed as a percentage of the nominal capacity.

The following experiments investigate the properties of discharge elements made of either nickel, copper, or aluminum. According to [V3], discharge elements made of nickel are normally used in the electrolyte LiAlCl₄*x SO₂ from the prior art, which is referred to below as the reference electrolyte. These nickel elements made of nickel are referred to below as nickel discharge elements (see Example 1). For this reason, experiments were carried out on the one hand in the reference electrolyte LiAlCl₄*x SO₂ and on the other hand in various electrolytes which can also be part of the inventive rechargeable battery cell. The electrical conductivities of copper and aluminum known from the literature are better than the electrical conductivity of nickel (see Table 1). Discharge elements made of copper and aluminum are therefore preferred within the scope of this disclosure.

TABLE 1
Electrical Conductivities of Copper, Aluminum, and Nickel

| | Electrical Conductivity σ/20° C. |
|---|---|
| Material | [S/m] |
| Copper | 5.80E+07 |
| Aluminum | 3.70E+07 |
| Nickel | 1.40E+07 |

Experiment 1: Behavior of Discharge Elements Made of Nickel and Copper for the Negative Electrode in Test Full Cells with a Reference Electrolyte of the Composition LiAlCl₄*4.5 SO₂

Negative electrodes were produced using graphite as the active material. These negative electrodes did not contain a binding agent. The discharge element of the first negative electrodes comprised copper in the form of a copper foam. The second negative electrodes contained a nickel discharge element in the form of a nickel foam. Nickel is the material for discharge elements from the prior art which is used in rechargeable battery cells with electrolytes of the composition LiAlCl₄*x SO₂.

Two negative electrodes with copper discharge elements were joined together with a positive electrode containing lithium iron phosphate as the active electrode material to form a first test full cell 1 according to Example 3. A second test full cell 2 according to Example 3 was constructed with the negative electrodes which contained nickel discharge elements. Both test full cells 1 and 2 were filled with a reference electrolyte according to Example 1 with the composition LiAlCl₄*4.5 SO₂.

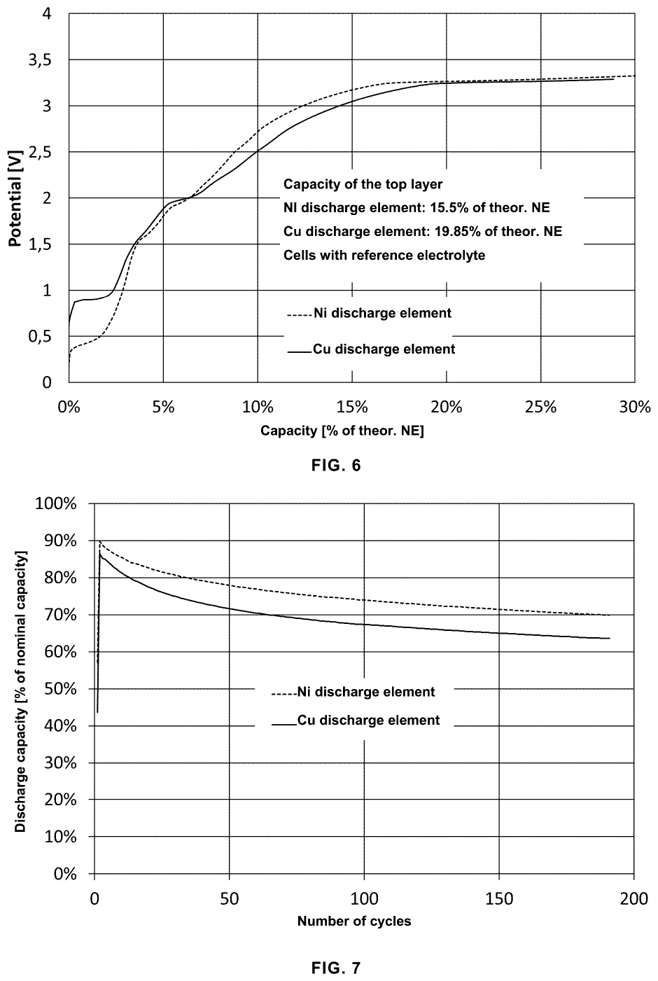

First, in the first cycle, the top layer capacities were determined according to Example 4. FIG. 6 shows the potential in volts of the test full cells when charging the negative electrode as a function of capacity in [%], which is related to the theoretical capacity of the negative electrode, the solid curve corresponding to test full cell 1 and the dashed curve corresponding to test full cell 2.

The two curves depicted show averaged results of several experiments with the test full cells 1 and 2 described above. First, the test full cells were charged with a current of 15 mA until a capacity of 125 mAh (Q_{lad}) was reached. The test full cells were then discharged at 15 mA until a potential of 2.5 volts was reached. The discharge capacity (Qₑₙₜ) was thereby determined.

Due to the lack of a binding agent in the negative electrode, the top layer capacities determined [in % of the theoretical capacity of the negative electrode] are higher than, e.g., the top layer capacities determined for electrodes containing a binding agent. In test full cell 1 with a graphite electrode with copper foam discharge element, the top layer capacity is 19.8% and in test full cell 2 with the graphite electrode with nickel foam discharge element it is 15.5%.

To determine the discharge capacities (see Example 4), the two test full cells 1 and 2 were charged at a charging rate of C/2 up to an upper potential of 3.8 volts. Then, the discharge took place at a discharge rate of C/2 up to a discharge potential of 2.5 volts.

FIG. 7 shows mean values for the discharge capacities of the two test full cells 1 and 2 as a function of the number of cycles, the solid curve corresponding to test full cell 1 and the dashed curve to test full cell 2. 190 cycles were performed. These mean values of the discharge capacities are each expressed as a percentage of the nominal capacity [% nominal capacity].

The course of the discharge capacities of the two test full cells 1 and 2 shows a uniform, decreasing course. However, the decrease in capacity is significantly greater in those test full cells that contained graphite electrodes with a copper foam discharge element. Thus, the capacity of test full cell 1 (nickel discharge element) at cycle 190 is still 70%, while the capacity of test full cell 2 (copper discharge element) at cycle 190 is only 64%.

In the reference electrolyte, a negative electrode that has a nickel discharge element shows a lower top layer capacity and better cycle behavior than a negative electrode with a copper discharge element. This also confirms the statements made in [V3], since nickel is the common discharge element in LiAlCl₄*x SO₂ electrolytes.

Experiment 2: Behavior of Discharge Elements Made of Nickel and Copper for the Negative Electrode in Test Full Cells with Electrolyte 1

Again, negative electrodes were produced with graphite as the active material. The discharge element of the first negative electrodes comprised copper in the form of a porous copper foam. The second negative electrodes contained a nickel discharge element in the form of a porous nickel foam.

Two negative electrodes with copper foam as the discharge element were joined together with a positive electrode containing lithium nickel manganese cobalt oxide (NMC 622) as the active electrode material to form a first test full cell according to Example 3. A second test full cell according to Example 3 was also constructed with the negative electrodes, which contained nickel foam as the discharge element. Both test full cells were filled with electrolyte 1 according to Example 2.

First, in the first cycle, the top layer capacities were determined according to Example 4.

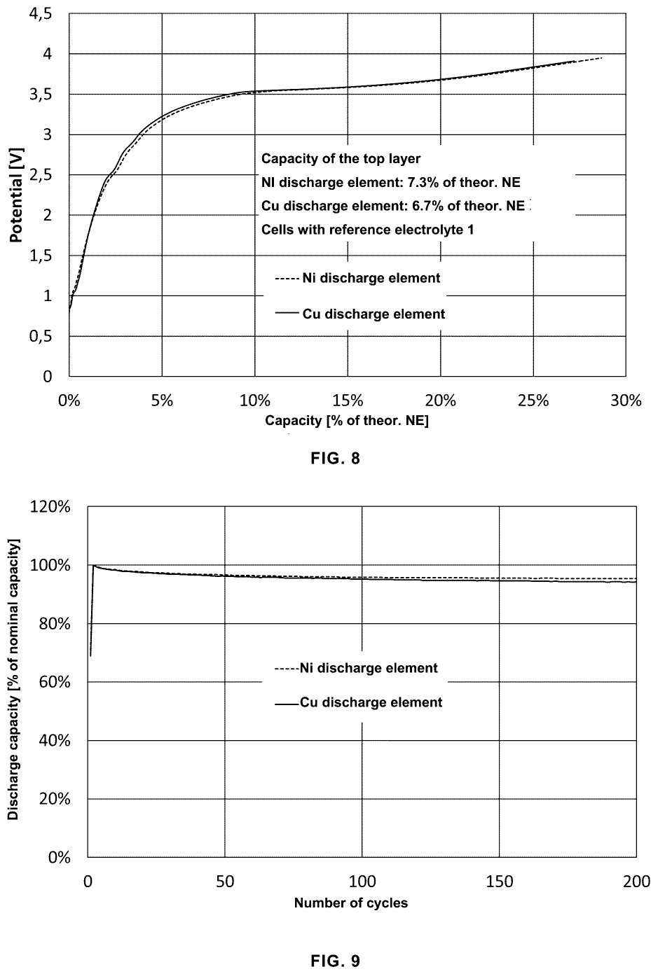

FIG. 8 shows the potential in volts of the two test full cells when charging the negative electrode as a function of the capacity in [%], which is related to the theoretical capacity of the negative electrode. The two curves depicted each show the averaged results of several experiments with the test full cells described above, the solid curve corresponding to the test full cell with the graphite electrode with copper discharge element and the dashed curve corresponding to the test full cell with the graphite electrode with nickel discharge element. First, the test full cells were charged with a current of 15 mA until a capacity of 125 mAh (Q_{lad}) was reached. The test full cells were then discharged at 15 mA until a potential of 2.5 volts was reached. The discharge capacity (Qₑₙₜ) was thereby determined.

In the test full cell with a graphite electrode with a copper discharge element, the top layer capacity is 6.7% and in the test full cell with the graphite electrode with a nickel discharge element it is 7.3%. The top layer capacity is smaller when using a copper discharge element than when using a nickel discharge element.

To determine the discharge capacities (see Example 4), the two test full cells were charged at a charging rate of C/2 up to an upper potential of 4.4 volts. Then, the discharge took place at a discharge rate of C/2 up to a discharge potential of 2.5 volts.

FIG. 9 shows mean values for the discharge capacities of the two test full cells as a function of the number of cycles, the solid curve corresponding to the test full cell with the graphite electrode with copper discharge element and the dashed curve corresponding to the test full cell with the graphite electrode with nickel discharge element. These mean values of the discharge capacities are each expressed as a percentage of the nominal capacity [% nominal capacity]. The course of the discharge capacities of the two test full cells shows an uniform, almost straight course. Only a slight decrease in capacity can be seen in both test full cells. Thus, the capacities of the two test full cells in cycle 200 are still approx. 95% (nickel discharge element) and 94% (copper discharge element).

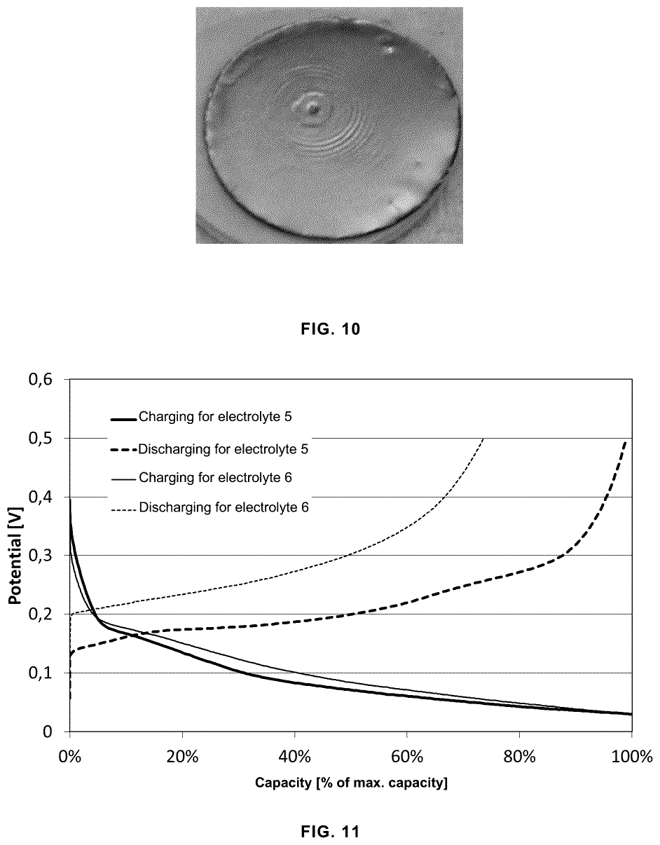

FIG. 10 shows a photograph of the copper discharge element after the measurement from FIG. 9 described above. This FIG. 10 shows that there was no corrosion on the copper discharge element during the experiment.

In the electrolyte 1, negative electrodes with a nickel discharge element and negative electrodes with a copper discharge element exhibit low top layer capacity and good cycle behavior. No corrosion can be seen on the copper discharge element after the experiment.

Experiment 3: Behavior of Discharge Elements Made of Copper for the Negative Electrode in Half-Cells with Electrolyte 5 and Electrolyte 6

Again, negative electrodes were produced with graphite as the active material. The discharge element of the electrodes comprised copper in the form of a copper film.

The experiments were carried out in half-cells with metallic lithium as counterelectrode and reference electrode. The working electrode was the graphite electrode to be investigated with a copper discharge element. The half-cells were filled with electrolyte 5, on the one hand, and electrolyte 6, on the other. The half-cells were charged at a charge/discharge rate of 0.02C up to a potential of 0.03 volts and discharged to a potential of 0.5 volts. FIG. 11 shows the potentials of the respective charging curves and discharging curves for the fourth cycle in electrolyte 5 and the second cycle in electrolyte 6 of the half-cells, the solid curves corresponding to the potentials of the charging curves and the dashed curves to the potentials of the discharging curves. The charging and discharging curves show stable, battery-typical behavior. Copper discharge elements are suitable as discharge elements of the negative electrode in electrolytes 5 and 6 and exhibit stable behavior.

Experiment 4: Behavior of Discharge Elements Made of Aluminum in Half-Cell Experiments with Reference Electrolyte and with Inventive Electrolyte 1

With these experiments, the long-term stability of aluminum discharge elements under current load in the reference electrolyte and in electrolyte 1 is to be investigated. The experiments were carried out in half-cells with metallic lithium as counterelectrode and reference electrode. The working electrodes were in each case the aluminum discharge element to be investigated in the form of an aluminum sheet. The half-cells were filled with a reference electrolyte with the composition LiAlCl₄x 1.5 SO₂ and with electrolyte 1.

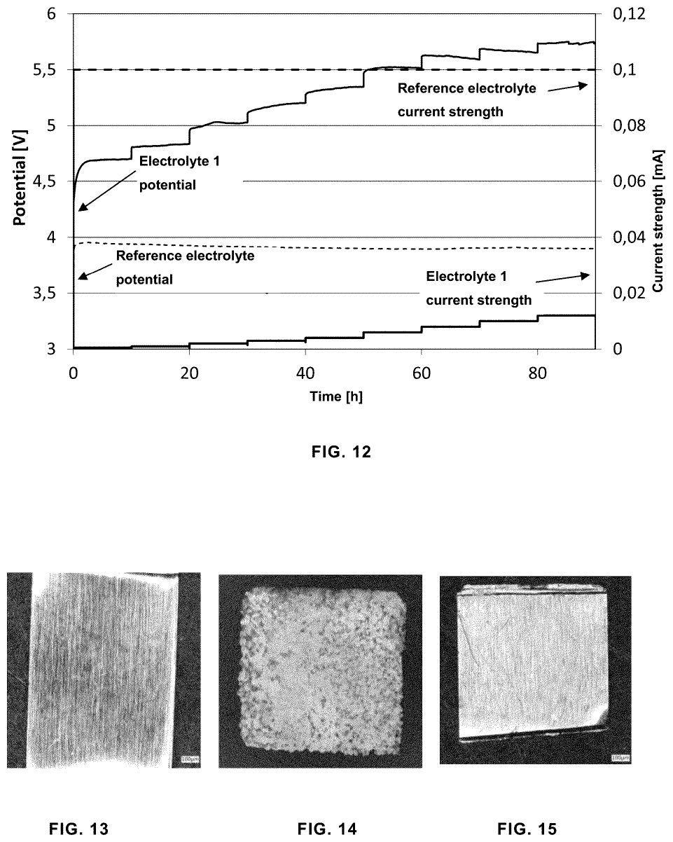

A constant current of 0.1 mA was applied to the half-cell with aluminum discharge element in reference electrolyte for a period of approx. 300 hours. The dashed lines in FIG. 12 show the current strength with the corresponding scale on the right-hand side of the diagram and the resulting potential (scale on the left-hand side) over a period of 90 hours. A potential of approx. 3.9 volts was observed over the entire time. After the experiment, the aluminum discharge element was removed from the half-cell and examined.

A constant current of 0.1 mA was also initially applied to the half-cell with aluminum discharge element in electrolyte 1. The experiment target potential of 5.0 V was reached after approx. just 2 minutes. The current was then reduced to 0.5 μA and gradually increased to current strengths of 1 μA, 2 μA, 3 μA, 4 μA, 6 μA, 8 μA, 10 μA, and 12 μA every 10 hours. The solid lines in FIG. 12 show the current strength with the corresponding scale on the right-hand side of the diagram and the resulting potential (scale on the left-hand side) over a period of 90 hours. After the experiment, the aluminum discharge element was removed from the half-cell and examined.

FIG. 13 shows an example of an aluminum discharge element that was introduced into the respective half-cell at the beginning of the measurements. FIG. 14 shows the aluminum discharge element after the experiment in the half-cell with reference electrolyte. Significant corrosion can be seen on the edges and the surface of the aluminum sheet after the experiment in the half-cell with reference electrolyte. This corrosion is also reflected in a very significant 61.5% loss of weight of the aluminum discharge element. Aluminum is not stable in the reference electrolyte during current load. FIG. 15 shows the aluminum discharge element after the experiment in the half-cell with electrolyte 1. There is no difference to be seen on the aluminum sheet compared to the beginning of the measurement, i.e., no corrosion can be observed on the discharge element. Aluminum is very stable under current load in the inventive electrolyte 1.

Experiment 5: Behavior of Discharge Elements Made of Aluminum for the Positive Electrode in Test Full Cells and Half-Cells with Electrolyte 1

To further investigate the aluminum discharge elements, the latter were coated with an active, positive material. Positive electrodes were produced using LiNi_{0.5}Mn_{1.5}O₄ (LNMO) as the active material. LNMO is an active material that is chargeable up to a high upper potential of, for example, 5 volts. The discharge element of the electrodes comprised aluminum in the form of an aluminum sheet. A half-cell with a lithium electrode as a counterelectrode and as a reference electrode was constructed with a positive electrode. The half-cell was filled with electrolyte 1. To determine the discharge capacities (see Example 4), the half-cells were charged or discharged at a charge/discharge rate of 0.1C up to a potential of 5 volts.

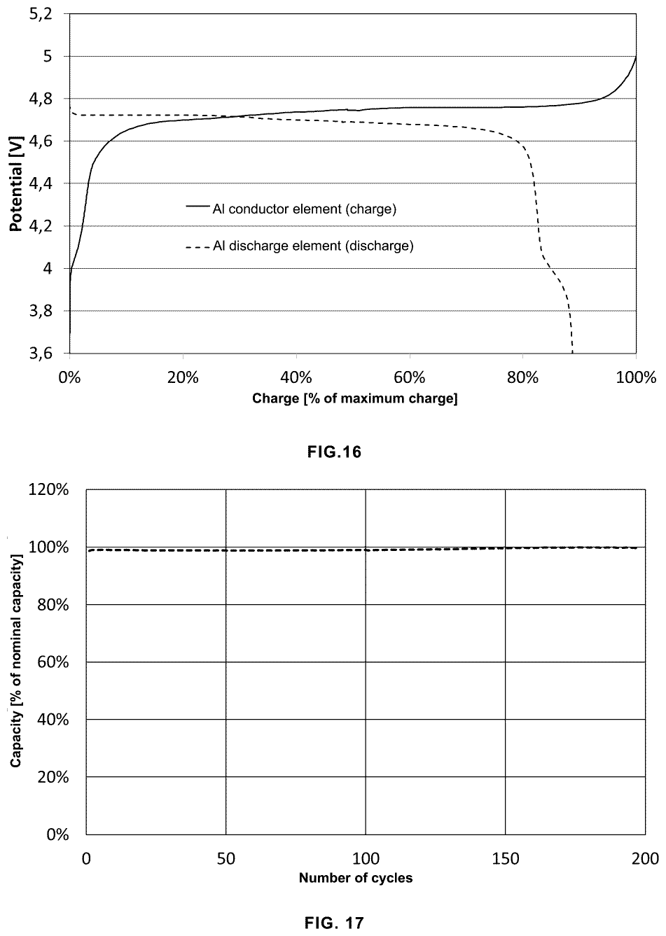

FIG. 16 shows the potentials of the charging curves (solid line) and discharging curves (dashed line) for the first cycle of the half-cell with aluminum discharge element as a function of capacity.

The charging and discharging curves show stable, battery-typical behavior. Aluminum discharge elements are very stable as discharge elements of the positive electrode in electrolyte 1.

Experiment 6: Behavior of Discharge Elements Made of Aluminum for the Positive Electrode in Test Full Cells with Electrolyte 1

To further test the stability of aluminum conductive elements, a test full cell was constructed with a positive electrode, which contained nickel manganese cobalt oxide (NMC622) as the active material and an aluminum film as the conductive element, and two negative electrodes. The negative electrodes contained graphite as the active material and a nickel discharge element. To determine the discharge capacities (see Example 4), the test full cell was charged at a charging rate of 0.1 C up to an upper potential of 4.4 volts. The discharge then took place at a discharge rate of 0.1 C up to a discharge potential of 2.8 volts. FIG. 17 shows the course of the discharge capacity over 200 cycles. The test full cell shows very stable behavior with an almost horizontal capacity curve. Thus, it can be confirmed that aluminum discharge elements are very stable as discharge elements of the positive electrode in electrolyte 1.

Experiment 7: Behavior of Discharge Elements Made of Aluminum for the Positive Electrode in Combination with Discharge Elements Made of Copper for the Negative Electrode in Full Cells with Electrolyte 1

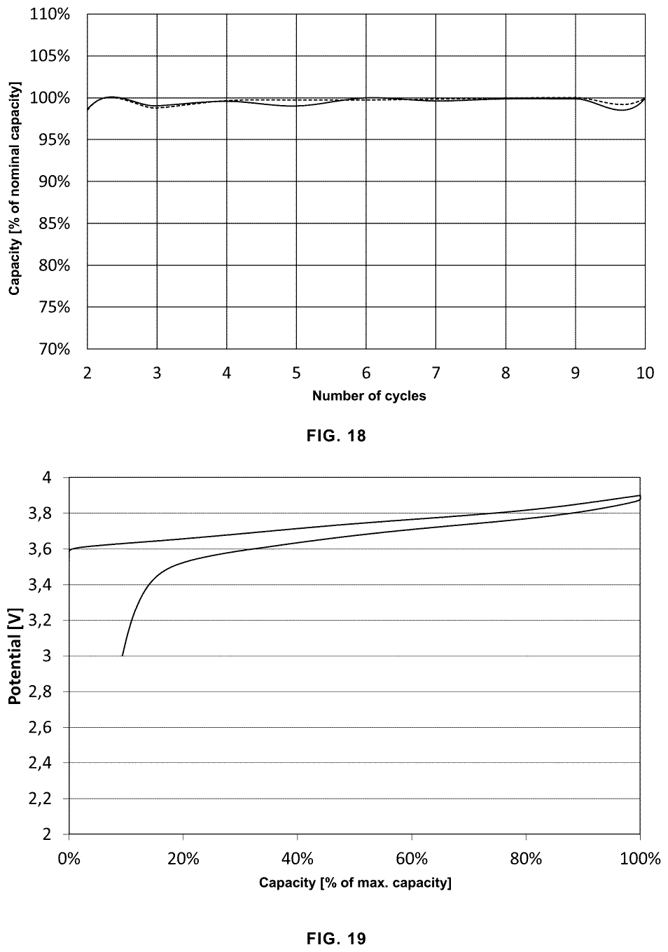

A full cell with 24 negative and 23 positive electrodes was set up in order to test the behavior of discharge elements made of aluminum for the positive electrode in combination with discharge elements made of copper for the negative electrode in full cells with inventive electrolyte 1. The positive electrodes contained nickel manganese cobalt oxide (NMC622) as the active material and an aluminum film as the discharge element. The negative electrodes contained graphite as the active material and a copper film as the discharge element. To determine the discharge capacities (see Example 4), the full cell was charged at a charging rate of 0.1 C up to different upper potentials of 4.3 V and 4.6 V. The charging capacity was limited to 50% of the theoretical cell capacity. The discharge then took place at a discharge rate of 0.1 C up to a discharge potential of 2.8 volts. FIG. 18 shows the course of the discharge capacities normalized to the maximum capacity of the full cells with an upper potential of 4.3 V and of the full cells with an upper potential of 4.6 V over 10 cycles. The full cells show a very stable behavior with an almost horizontal capacity curve, even when measuring with a higher upper potential. It can thus be confirmed that aluminum discharge elements for the positive electrode in combination with copper discharge elements for the negative electrode are very stable in full cells with electrolyte 1.

Experiment 8: Behavior of Discharge Elements Made of Aluminum for the Positive Electrode in Half-Cells with Electrolyte 5

Positive electrodes were produced using nickel manganese cobalt oxide (NMC811) as the active material. The discharge element of the positive electrodes comprised aluminum in the form of an aluminum film. The experiments were carried out in half-cells with metallic lithium as counterelectrode and reference electrode. The working electrode was the positive electrode to be investigated with an aluminum discharge element. The half-cell was filled with electrolyte 5. To determine the discharge capacities (see Example 4), the half-cells were charged at a charge/discharge rate of 0.02 C up to a potential of 3.9 volts and discharged to a potential of 3 volts.

FIG. 19 shows the potential during charging and for the second cycle of the half-cell with an aluminum discharge element as a function of the capacity.

The charging and discharging curves show stable, battery-typical behavior. Aluminum discharge elements are very stable as discharge elements of the positive electrode in electrolyte 5.

### Experiment 8: Investigation of Electrolytes 1, 3, 4, and 5

Various experiments were carried out to investigate electrolytes 1, 3, 4, and 5. For one thing, the top layer capacities of electrolytes 1 and 3 and the reference electrolyte were determined, and in addition the discharge capacities in electrolytes 1, 3, 4 and 5 were determined.

To determine the top layer capacity, three test fulls were filled with electrolytes 1 and 3 described in Example 2 and the reference electrolyte described in Example 1. The three test full cells contained lithium iron phosphate as the active material for the positive electrode.

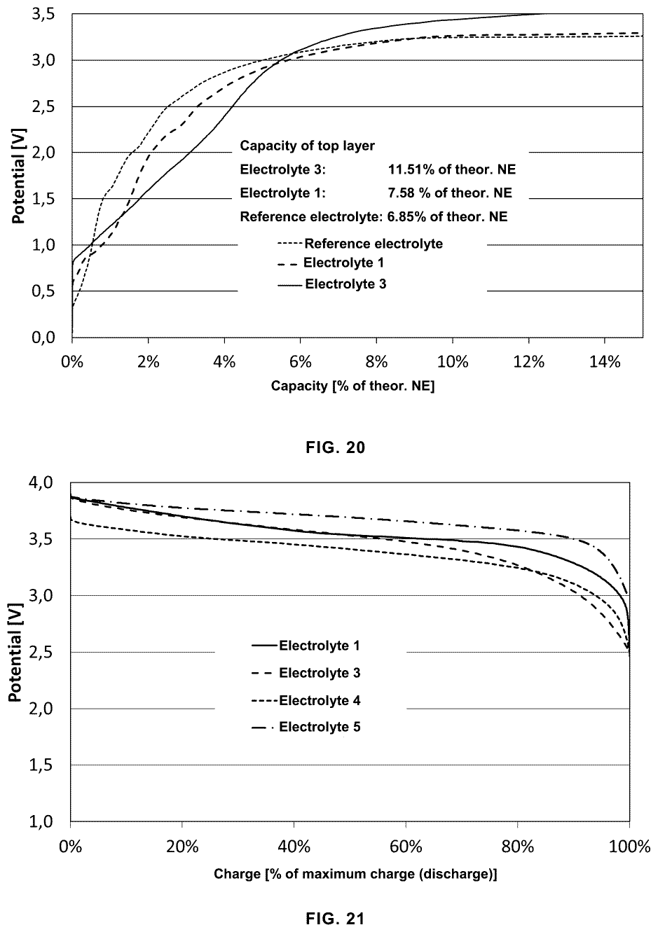

FIG. 20 shows the potential in volts of the test full cells when charging the negative electrode as a function of capacity, which is related to the theoretical capacity of the negative electrode. The two curves depicted each show averaged results of several experiments with the test full cells described above. First, the test full cells were charged with a current of 15 mA until a capacity of 125 mAh (Q_{lad}) was reached. The test full cells were then discharged at 15 mA until a potential of 2.5 volts was reached. The discharge capacity (Qₑₙₜ) was thereby determined.

The absolute capacity losses are 7.58% and 11.51% for electrolytes 1 and 3 and 6.85% for the reference electrolyte. The capacity for the formation of the top layer is somewhat higher for both inventive electrolytes than for the reference electrolyte. Values in the range of 7.5%-11.5% for the absolute capacity losses are good results in combination with the possibility of using high-voltage cathodes up to 5 volts.

For the discharge experiments, four test full cells were filled according to Example 3 with electrolytes 1, 3, 4 and 5 described in Example 2. The test full cells had lithium nickel manganese cobalt oxide (NMC) as the active material for the positive electrode. To determine the discharge capacities (see Example 4), the test full cells were charged with a current strength of 15 mA up to a capacity of 125 mAh. Then, the discharge took place with a current strength of 15 mA up to a discharge potential of 2.5 volts.

FIG. 21 shows the course of the potential during the discharge over the amount of charge discharged in % [% of the maximum charge (discharge)]. All test full cells show a flat discharge curve, which is necessary for good battery cell operation.

### Experiment 9: Determination of Conductivities of Electrolytes 1, 3, 4, 5, and 6

To determine the conductivity, electrolytes 1, 3, 4, 5, and 6 were prepared with different concentrations of compounds 1, 3, 4, 5, and 6. For each concentration of the different compounds, the conductivities of the electrolytes were determined using a conductive measurement method. After bringing to temperature, a four-electrode sensor was held touching the solution and measured in a measuring range of 0.02-500 mS/cm.

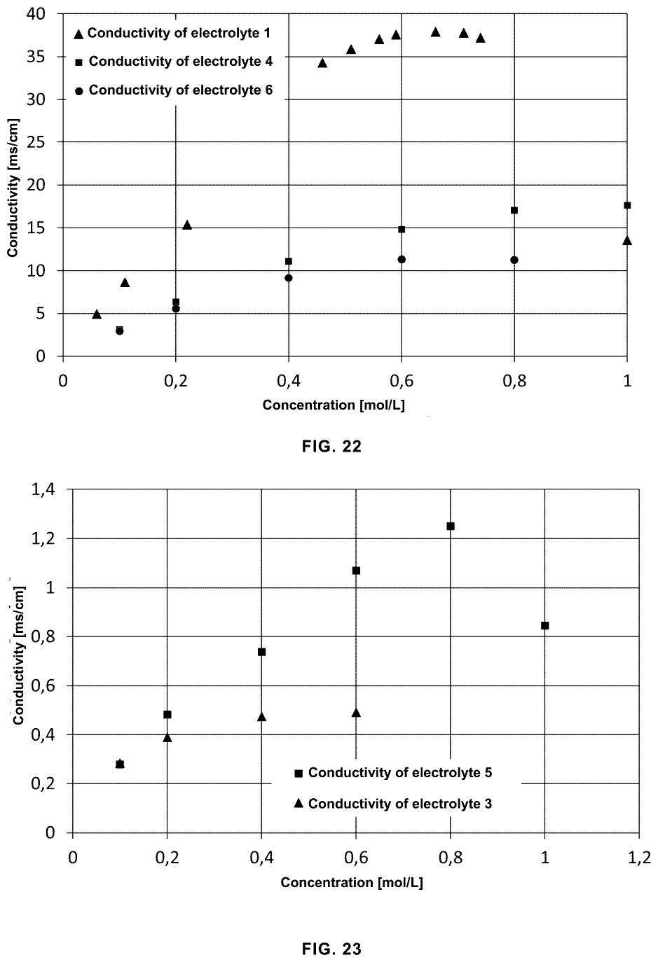

FIG. 22 shows the conductivities of electrolytes 1, 4, and 6 as a function of the concentration of compounds 1, 4, and 6. In the case of electrolyte 1, a maximum conductivity can be seen at a concentration of compound 1 of 0.6 mol/L-0.7 mol/L with a value of approx. 37.9 mS/cm. In comparison, the organic electrolytes known from the prior art, such as, e.g., LP30 (1 M LiPF6/EC-DMC (1:1 by weight)) have a conductivity of only approx. 10 mS/cm. In the case of electrolyte 4, a maximum of 18 mS/cm is achieved at a conductive salt concentration of 1 mol/L. Electrolyte 6 shows a maximum of 11 mS/cm at a conductive salt concentration of 0.6 mol/L.

FIG. 23 shows the conductivities of electrolytes 3 and 5 as a function of the concentration of compounds 3 and 5. In the case of electrolyte 5, a maximum of 1.3 mS/cm is achieved at a conductive salt concentration of 0.8 mol/L. Electrolyte 3 shows its highest conductivity of 0.5 mS/cm at a conductive salt concentration of 0.6 mol/L. Although electrolytes 3 and 5 show lower conductivities, charging or discharging a test half-cell, as described, e.g., in Experiment 3, or a test full cell as described in Experiment 8, is quite possible.

### Experiment 10: Low Temperature Behavior

In order to determine the low-temperature behavior of electrolyte 1 in comparison to the reference electrolyte, two test full cells were produced according to Example 3. One test full cell was filled with reference electrolyte of the composition LiAlCl₄*6SO₂ and the other test full cell with electrolyte 1. The test full cell with the reference electrolyte contained lithium iron phosphate (LEP) as the active material; the test cell with electrolyte 1 contained lithium nickel manganese cobalt oxide (NMC) as the positive electrode active material. The test full cells were charged at 20° C. to 3.6 volts (LEP) or 4.4 volts (NMC) and discharged again to 2.5 volts at the temperature to be investigated. The discharge capacity achieved at 20° C. was found to be 100%. The discharge temperature was lowered in increments of 10° K. The discharge capacity obtained was described in % of the discharge capacity at 20° C. Since the low-temperature discharges are almost independent of the active materials used in the positive and negative electrodes, the results can be transferred to all combinations of active materials. Table 5 shows the results.

The test full cell with electrolyte 1 shows very good low-temperature behavior. 82% of the capacity is still reached at −20° C., and 73% is reached at −30° C. Even at a temperature of −40° C., 61% of the capacity can still be discharged. In contrast, the test full cell with the reference electrolyte is able to discharge only down to −10° C. A capacity of 21% is achieved. At lower temperatures, the cell with the reference electrolyte can no longer be discharged.

TABLE 5
Discharge Capacities as a Function of Temperature

| | | Discharge Capacity of | Discharge Capacity of the |
|---|---|---|---|
| Temperature | | Electrolyte 1 | Reference Electrolyte |
| 20° | C. | 100% | 100% |
| 10° | C. | 99% | 99% |
| 0° | C. | 95% | 46% |
| −10° | C. | 89% | 21% |
| −20° | C. | 82% | N/A |
| −30° | C. | 73% | N/A |
| −35° | C. | 68% | N/A |
| −40° | C. | 61% | N/A |

While exemplary embodiments have been disclosed hereinabove, the present invention is not limited to the disclosed embodiments. Instead, this application is intended to cover any variations, uses, or adaptations of this disclosure using its general principles. Further, this application is intended to cover such departures from the present disclosure as come within known or customary practice in the art to which this invention pertains and which fall within the limits of the appended claims.

What is claimed is:

1. A rechargeable battery cell, comprising:
an active metal;
a positive electrode with a discharge element;
a negative electrode with a discharge element;
a housing; and
an electrolyte;
wherein the discharge element of the positive electrode and the discharge element of the negative electrode are embodied independently of one another from a material selected from the group consisting of aluminum and copper;
wherein the electrolyte is based on SO₂ and contains a first conductive salt which has the formula (I) 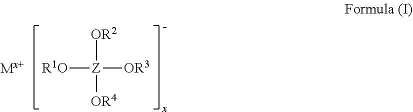
wherein;
M is a metal selected from the group consisting of alkali metals, alkaline earth metals, metals from group 12 of the periodic table of elements, and aluminum;
x is an integer from 1 to 3;
the substituents R¹, R², R³, and R⁴ are selected independently of one another from the group consisting of substituted or unsubstituted C₁-C₁₀ alkyl, C₂-C₁₀ alkenyl, C₂-C₁₀ alkynyl, C₃-C₁₀ cycloalkyl, C₆-C₁₄ aryl, and C₅-C₁₄ heteroaryl; and
wherein Z is aluminum or boron.

2. The rechargeable battery cell according to claim 1, wherein the discharge element of the positive electrode comprises aluminum.

3. The rechargeable battery cell according to claim 1, wherein the discharge element of the negative electrode comprises copper.

4. The rechargeable battery cell according to claim 1, wherein the discharge element of the positive electrode and/or the discharge element of the negative electrode is either planar in the form of a metal sheet, metal film, optionally with a perforated or net-like structure, or metal-coated plastic film, or three-dimensional in the form of a porous metal structure.

5. The rechargeable battery cell of claim 4, wherein the discharge element of the positive electrode and/or the negative electrode comprises the porous metal structure and the porous metal structure comprises a metal foam.

6. The rechargeable battery cell according to claim 1, wherein the cell voltage of the battery cell is selected from the group consisting of at least 4.0 volts, at least 4.4 volts, at least 4.8 volts, at least 5.2 volts, at least 5.6 volts, and at least 6.0 volts.

7. The rechargeable battery cell according to claim 1, wherein the substituents R¹, R², R³, and R⁴ of the first conductive salt are selected independently of one another from the group consisting of:
C₁-C₆ alkyl;
C₂-C₆ alkenyl;
C₂-C₆ alkynyl;
C₃-C₆ cycloalkyl;
phenyl; and
C₅-C₇ heteroaryl.

8. The rechareable battery cell according to claim 7, wherein the first conductive salt comprises C₂-C₄ alkyl.

9. The rechareable battery cell according to claim 7, wherein the C₁-C₆ alkyl comprises a 2-propyl, methyl, or an ethyl group.

10. The rechareable battery cell according to claim 7, wherein the first conductive salt comprises C₂-C₄ alkenyl.

11. The rechareable battery cell according to claim 10, wherein the C₂-C₄ alkenyl comprises an ethenyl or propenyl group.

12. The rechareable battery cell according to claim 7, wherein the first conductive salt comprises C₂-C₄ alkynyl.

13. The rechargeable battery cell according to claim 1, wherein at least two of the substituents R¹, R², R³, and R⁴ are bridged with one another to form a chelating ligand.

14. The rechargeable battery cell according to claim 1, wherein at least one of the substituents R¹, R², R³, and R⁴ of the first conductive salt is substituted by at least one fluorine atom and/or by at least one chemical group selected from the group consisting of C₁-C₄ alkyl, C₂-C₄ alkenyl, C₂-C₄ alkynyl, phenyl, and benzyl.

15. The rechargeable battery cell according to claim 1, wherein at least one of the substituents R¹, R², R³, and R⁴ of the first conductive salt is a CF₃ group or an OSO₂CF₃ group.

16. The rechargeable battery cell according to claim 1, wherein the first conductive salt is selected from the group consisting of:

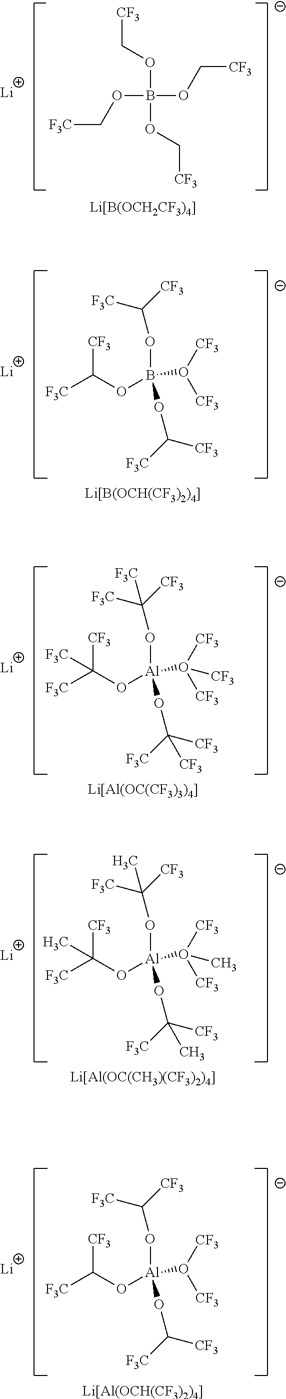

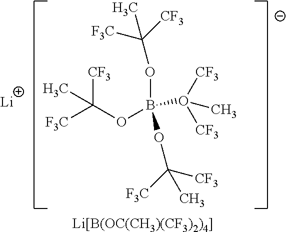

17. The rechargeable battery cell according to claim 1, wherein the first conductive salt has the following formula

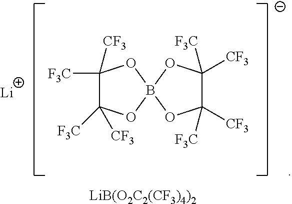

18. The rechargeable battery cell according to claim 1, wherein the electrolyte contains at least one second conductive salt which differs from the first conductive salt according to formula (I).

19. The rechargeable battery cell according to claim 18, wherein the second conductive salt of the electrolyte is an alkali metal compound.

20. The rechargeable battery cell according to claim 19, wherein the alkali metal compound comprises a lithium compound.

21. The rechargeable battery cell according to claim 20, wherein the lithium compound is selected from the group consisting of a lithium tetrahaloaluminate, a halide, an oxalate, a borate, a phosphate, an arsenate and a gallate.

22. The rechargeable battery cell according to claim 1, wherein the electrolyte contains an additive.

23. The rechargeable battery cell according to claim 22, wherein the additive of the electrolyte is selected from the group consisting of vinylene carbonate and its derivatives, vinyl ethylene carbonate and its derivatives, methyl ethylene carbonate and its derivatives, lithium (bisoxalato)borate, lithium difluoro(oxalato)borate, lithium tetrafluoro(oxalato)phosphate, lithium oxalate, 2-vinylpyridine, 4-vinylpyridine, cyclic exomethylene carbonates, sulfones, cyclic and acyclic sulfonates, acyclic sulfites, cyclic and acyclic sulfinates, organic esters, inorganic acids, acyclic and cyclic alkanes, which acyclic and cyclic alkanes have a boiling point of at least 36° C. at 1 bar, aromatic compounds, halogenated cyclic and acyclic sulfonylimides, halogenated cyclic and acyclic phosphate esters, halogenated cyclic and acyclic phosphines, halogenated cyclic and acyclic phosphites, halogenated cyclic and acyclic phosphazenes, halogenated cyclic and acyclic silylamines, halogenated cyclic and acyclic halogenated esters, halogenated cyclic and acyclic amides, halogenated cyclic and acyclic anhydrides, and halogenated organic heterocycles.

24. The rechargeable battery cell according to claim 1, wherein the electrolyte has the composition:
(i) 5 to 99.4 wt. % sulfur dioxide;
(ii) 0.6 to 95 wt. % of the first conductive salt;
(iii) 0 to 25 wt. % of the second conductive salt; and
(iv) 0 to 10% by weight of the additive;
based on the total weight of the electrolyte composition.

25. The rechargeable battery cell according to claim 1, wherein the molar concentration of the first conductive salt is in a range selected from the group consisting of 0.01 mol/L to 10 mol/L, 0.05 mol/L to 10 mol/L, 0.1 mol/L to 6 mol/L, and 0.2 mol/L to 3.5 mol/L based on the total volume of the electrolyte.

26. The rechargeable battery cell according to claim 1, wherein the electrolyte contains an amount of SO₂ selected from the group consisting of at least 0.1 mole SO₂, at least 1 mole SO₂, at least 5 moles SO₂, at least 10 moles SO₂, and at least 20 moles SO₂ per mole of conductive salt.

27. The rechargeable battery cell according to claim 1, wherein the active metal is an alkali metal, an alkaline earth metal, or a metal from group 12 of the periodic table.

28. The rechargeable battery cell according to claim 27, wherein the active metal comprises lithium or sodium.

29. The rechargeable battery cell according to claim 27, wherein the active metal comprises calcium.

30. The rechargeable battery cell according to claim 27, wherein the active metal comprises zinc.

31. The rechargeable battery cell according to claim 1, wherein the positive electrode contains as active material at least one compound which has the composition AₓM′_{y}M″_{z}Oₐ, wherein:
A is at least one metal selected from the group consisting of the alkali metals, alkaline earth metals, metals of group 12 of the periodic table, and aluminum;
M′ is at least one metal selected from the group consisting of the elements Ti, V, Cr, Mn, Fe, Co, Ni, Cu, and Zn;
M″ is at least one element selected from the group consisting of the elements of groups 2, 3, 4, 5, 6, 7, 8, 9, 10, 11, 12, 13, 14, 15, and 16 of the periodic table of elements;
x and y, independently of one another, are numbers greater than 0;
z is a number greater than or equal to 0; and
a is a number greater than 0.

32. The rechargeable battery cell according to claim 31, wherein the compound has the composition LiₓNi_{y1}Mn_{y2}Co_{z}Oₐ, where x, y1, and y2, independently of one another, are numbers greater than 0, z is a number greater than or equal to 0, and a is a number greater than 0.

33. The rechargeable battery cell according to claim 31, wherein the compound has the composition AₓM′_{y}M″¹_{z1}M″²_{z2}O₄, wherein:
M″¹ is selected from the group consisting of the elements of groups 2, 3, 4, 5, 6, 7, 8, 9, 10, 11, 12, 13, 14, 15, and 16 of the periodic table of elements;
M″² is the element phosphorus;
x and y, independently of one another, are numbers greater than 0;
z1 is a number greater than 0; and
z2 has the value 1.

34. The rechargeable battery cell according to claim 1, wherein the positive electrode contains at least one metal compound selected from the group consisting of a metal oxide, a metal halide, and a metal phosphate.

35. The rechargeable battery cell according to claim 34, wherein the metal compound comprises a transition metal with atomic numbers 22 to 28 of the periodic table of the elements.

36. The rechargeable battery cell according to claim 35, wherein the metal compound comprises cobalt, nickel, manganese or iron.

37. The rechargeable battery cell according to claim 1, wherein the positive electrode contains at least one metal compound having the chemical structure of a spinel, a layered oxide, a conversion compound, or a polyanionic compound.

38. The rechargeable battery cell according to claim 1, wherein the negative electrode is an insertion electrode.

39. The rechargeable battery cell according to claim 38, wherein the insertion electrode comprises carbon as the active material.

40. The rechargeable battery cell according to claim 39, wherein the carbon comprises graphite.

41. The rechargeable battery cell according to claim 1, wherein the positive electrode and/or the negative electrode comprises a binder, the binder comprising:
a polyvinylidene fluoride and/or a terpolymer of tetrafluoroethylene, hexafluoropropylene and vinylidene fluoride; or
a polymer built up from monomeric structural units of a conjugated carboxylic acid or from the alkali metal, alkaline earth metal or ammonium salt of this conjugated carboxylic acid or from a combination thereof; or
a binding agent comprising a polymer based on monomeric styrene and butadiene structural units; or
a binding agent from the group of carboxymethyl celluloses;
wherein the binding agent is present in a concentration selected from the group consisting of at most 20 wt. %, at most 15 wt. %, at most 10 wt. %, at most 7 wt. %, at most 5 wt. %, and at most 2 wt. % based on the total weight of the positive electrode or the negative electrode.

42. The rechargeable battery cell according to claim 1, wherein the negative electrode comprises a plurality of negative electrodes and the positive electrode comprises a plurality of positive electrodes, the negative and the positive electrodes arranged alternately in a stack in the housing.

43. The rechargeable battery cell according to claim 42, wherein the positive and negative electrodes in the stack are electrically separated from one another by separators.
